(19) United States
(12) Patent Application Publication
(10) Pub. No.: US 2018/0311931 A1
(43) Pub. Date: Nov. 1, 2018

(54) MULTI-LAYER ASSEMBLIES COMPRISING A REINFORCED THERMOPLASTIC SURFACE LAYER AND A CORE LAYER

(71) Applicants: Todd Richard Wodzinski, Troy, MI (US); Mark John Mason, Howell, MI (US); Yune Seo Park, Brighton, MI (US); Anthony Joseph Messina, Macomb Township, MI (US); Peter Thomas Evers, JR., Byron, MI (US); Mark O Mason, Covington, VA (US)

(72) Inventors: Todd Richard Wodzinski, Troy, MI (US); Mark John Mason, Howell, MI (US); Yune Seo Park, Brighton, MI (US); Anthony Joseph Messina, Macomb Township, MI (US); Peter Thomas Evers, JR., Byron, MI (US); Mark O Mason, Covington, VA (US)

(21) Appl. No.: 15/918,518

(22) Filed: Mar. 12, 2018

Related U.S. Application Data
(60) Provisional application No. 62/470,691, filed on Mar. 13, 2017.

(51) Int. Cl. B32B 5/32; B32B 3/26; B32B 27/18; B32B 27/06; B32B 7/12; B32B 27/08; B32B 5/18; B32B 27/32

(52) U.S. Cl. CPC B32B 5/32; B32B 3/26; B32B 27/18; B32B 27/065; B32B 7/12; B32B 27/08; B32B 2266/06; B32B 27/32; B32B 2250/22; B32B 2262/101; B32B 2266/0228; B32B 2250/24; B32B 2266/08; B32B 5/18

(57) ABSTRACT

Certain configurations are described herein of a multi-layer assembly comprising a core layer and one or more reinforced thermoplastic layers. In some configurations, the core layer may comprise a directionally compressive material. In other configurations, the reinforced thermoplastic layer may comprise a thermoplastic material and reinforcing fibers. Vehicle load floors, wall panels, flooring panels and the like including the multi-layer assembly are also described.

### PRIORITY APPLICATION

This application is related to and claims priority to and the benefit of U.S. Provisional Application No. 62/470,691 filed on Mar. 13, 2017, the entire disclosure of which is hereby incorporated herein by reference for all purposes.

### TECHNOLOGICAL FIELD

This application is related to reinforced thermoplastic composites and their use in vehicles. More particularly, certain embodiments described herein are directed to multi-layered assemblies comprising a reinforced thermoplastic surface layer in combination with a core layer and their use in vehicles and other applications.

### BACKGROUND

Articles for automotive and construction materials applications typically are designed to meet a number of competing and stringent performance specifications.

### SUMMARY

Certain configurations are described herein that are directed to multi-layer assemblies, and components thereof, that may include one or more porous, reinforced thermoplastic surface layers in combination with a substantially non-porous core layer or a core layer that is not a reinforced thermoplastic layer. While certain specific configurations are described in detail below, the exact materials present in the surface layers and the core layer can vary depending on the intended use of the multi-layer assembly.

In one aspect, a multi-layer assembly comprises a core layer comprising a closed cell material, a first reinforced thermoplastic layer disposed on the first surface of the core layer, the first fiber reinforced thermoplastic layer comprising a web of open celled structures formed by a plurality of reinforcing materials bonded together with a thermoplastic material, and a second reinforced thermoplastic layer disposed on the second surface of the core layer, the second fiber reinforced thermoplastic layer comprising a web of open celled structures formed by a plurality of reinforcing materials bonded together with a thermoplastic material.

In certain configurations, the closed cell material is not a polyurethane foam or wherein the core layer is cellulose free. In other configurations, the core layer comprises a polyurethane material, e.g., a polyurethane foam, or a cellulose based material, e.g., paper, honeycomb, etc. In certain examples, a basis weight of the first reinforced thermoplastic layer is substantially the same as a basis weight of the second reinforced thermoplastic layer. In some embodiments, a basis weight of the first reinforced thermoplastic layer is different than a basis weight of the second reinforced thermoplastic layer. In certain examples, the first reinforced thermoplastic layer disposed comprises at least one different reinforcing material than a reinforcing material of the second reinforced thermoplastic layer disposed. In other examples, the closed cell material of the core layer comprises a directionally compressive foam that is selected from the group consisting of a directionally compressive expanded polystyrene foam, a directionally compressive extruded polyethylene foam and a directionally compressive expandable polypropylene foam. In some examples, the thermoplastic material in the first reinforced thermoplastic layer is different than the thermoplastic material in the second reinforced thermoplastic layer. In further examples, the thermoplastic material in the first reinforced thermoplastic layer and the second reinforced thermoplastic layer are the same. In some embodiments, the reinforcing materials in the first reinforced thermoplastic layer and the second reinforced thermoplastic layer are the same. In other instances, the reinforcing materials of the first reinforced thermoplastic layer and the second reinforced thermoplastic layer each comprise reinforcing fibers. In some configurations, the first fiber reinforced thermoplastic layer comprises at least one different reinforcing fiber than reinforcing fibers of the second fiber reinforced thermoplastic layer. In other configurations, one or both of the first fiber reinforced thermoplastic layer and the second fiber reinforced thermoplastic layer comprise a lofting agent. In some examples, the lofting agent comprises at least one of expandable microspheres and expandable graphite materials. In additional examples, no lofting agent is present in the core layer. In other examples, the thermoplastic material and reinforcing materials of the first fiber reinforced thermoplastic layer and the second fiber reinforced thermoplastic layer are selected to permit lofting of the first fiber reinforced thermoplastic layer and the second fiber reinforced thermoplastic layer without a lofting agent being present. In some embodiments, the multi-layer assembly further comprises a first adhesive layer disposed on the first surface of the core layer between the first reinforced thermoplastic layer and the core layer. In additional examples, the multi-layer assembly further comprises, a second adhesive layer disposed on the second surface of the core layer between the second reinforced thermoplastic layer and the core layer. In some configurations, the multi-layer assembly comprises a decorative layer disposed on one of the first reinforced thermoplastic layer and the second reinforced thermoplastic layer. In some examples, the closed cell material of the core layer comprises a directionally compressive expanded polystyrene foam, the first fiber reinforced thermoplastic layer comprises polypropylene and glass fibers, the second fiber reinforced thermoplastic layer comprises polypropylene and glass fibers and the first and second adhesive layers each comprise a co-polyamide. In some examples, at least one of the core layer, the first reinforced thermoplastic layer and the second reinforced thermoplastic layer comprises a flame retardant material. In certain instances, the flame retardant material comprises one or more of expandable graphite materials, magnesium hydroxide and aluminum hydroxide.

In another aspect, a multi-layer assembly comprises a core layer comprising a closed cell material without any polyurethane or cellulose material, wherein the closed cell material is substantially non-porous and provides directionally compressive strength to the multi-layer assembly, a first adhesive layer disposed on a first surface of the core layer, a second adhesive layer disposed on a second surface of the core layer, a first fiber reinforced thermoplastic layer disposed on the first adhesive layer, the first fiber reinforced thermoplastic layer comprising a web of open celled structures formed by a plurality of reinforcing fibers bonded together with a thermoplastic material, and a second fiber reinforced thermoplastic layer disposed on the second adhesive layer, the second fiber reinforced thermoplastic layer comprising a web of open celled structures formed by a plurality of reinforcing fibers bonded together with a thermoplastic material.

In certain examples, the core layer comprises a directionally compressive foam. In other examples, the directionally compressive foam is selected from the group consisting of a directionally compressive expanded polystyrene foam, a directionally compressive extruded polyethylene foam and a directionally compressive expandable polypropylene foam or, in the alternative, a polyurethane foam or a cellulose based material. In some embodiments, a basis weight of the first fiber reinforced thermoplastic layer is substantially the same as a basis weight of the second fiber reinforced thermoplastic layer. In some examples, a basis weight of the first fiber reinforced thermoplastic layer is different than a basis weight of the second fiber reinforced thermoplastic layer. In other examples, the first fiber reinforced thermoplastic layer disposed comprises at least one different reinforcing fiber material than a reinforcing fiber material of the second fiber reinforced thermoplastic layer disposed. In certain instances, the thermoplastic material in the first fiber reinforced thermoplastic layer is different than the thermoplastic material in the second fiber reinforced thermoplastic layer. In some examples, the thermoplastic material in the first fiber reinforced thermoplastic layer and the second fiber reinforced thermoplastic layer are the same. In further examples, the reinforcing fibers in the first fiber reinforced thermoplastic layer and the second fiber reinforced thermoplastic layer are the same. In some instances, the first fiber reinforced thermoplastic layer further comprises at least one different reinforcing fiber than the reinforcing fibers of the second fiber reinforced thermoplastic layer. In other examples, one or both of the first fiber reinforced thermoplastic layer and the second fiber reinforced thermoplastic layer comprise a lofting agent. In some examples, the lofting agent comprises at least one of expandable microspheres and expandable graphite materials. In certain examples, no lofting agent is present in the core layer. In certain configurations, the thermoplastic material and reinforcing materials of the first fiber reinforced thermoplastic layer and the second fiber reinforced thermoplastic layer are selected to permit lofting of the first fiber reinforced thermoplastic layer and the second fiber reinforced thermoplastic layer without a lofting agent being present. In other configurations, the multi-layer assembly comprises a skin layer disposed on one of the first fiber reinforced thermoplastic layer and the second fiber reinforced thermoplastic layer, wherein the skin layer comprises a fabric, a scrim, a film and combinations thereof. In some instances, the multi-layer assembly comprises a decorative layer coupled to one of the first fiber reinforced thermoplastic layer and the second reinforced thermoplastic layer. In certain examples, the thermoplastic material of each of the first fiber reinforced thermoplastic layer and the second fiber reinforced thermoplastic layer is independently selected from the group consisting of a polyolefin material, a thermoplastic polyolefin blend material, a polyvinyl polymer material, a butadiene polymer material, an acrylic polymer material, a polyamide material, a polyester material, a polycarbonate material, a polyestercarbonate material, a polystyrene material, an acrylonitrylstyrene polymer material, an acrylonitrile-butylacrylate-styrene polymer material, a polyether imide material, a polyphenylene ether material, a polyphenylene oxide material, a polyphenylenesulphide material, a polyether material, a polyetherketone material, a polyacetal material, a polyurethane material, a polybenzimidazole material, and copolymers and mixtures thereof. In other examples, the reinforcing materials of each of the first fiber reinforced thermoplastic layer and the second fiber reinforced thermoplastic layer is independently selected from the group consisting of glass fibers, carbon fibers, graphite fibers, synthetic organic fibers, inorganic fibers, natural fibers, mineral fibers, metal fibers, metalized inorganic fibers, metalized synthetic fibers, ceramic fibers, and combinations thereof. In some embodiments, the fibers present in of each of the first fiber reinforced thermoplastic layer and the second fiber reinforced thermoplastic layer independently comprise a diameter greater than about 5 microns and a length from about 5 mm to about 200 mm. In other embodiments, the directionally compressive foam is directionally compressive expanded polystyrene foam, wherein each of the first and second fiber reinforced thermoplastic layers comprise polypropylene and glass fibers, wherein the multi-layer assembly further comprises a skin coupled to the second fiber reinforced thermoplastic layer, and wherein the multi-layer assembly further comprises a decorative layer coupled to the skin. In some examples, at least one of the core layer, the first reinforced thermoplastic layer and the second reinforced thermoplastic layer comprises a flame retardant material. In certain instances, the flame retardant material comprises one or more of expandable graphite materials, magnesium hydroxide and aluminum hydroxide. If desired, the adhesive layers may also comprise a flame retardant material.

In another aspect, a vehicle load floor that provides structural reinforcement comprises a core layer comprising a closed cell material, a first reinforced thermoplastic layer disposed on the first surface of the core layer, the first fiber reinforced thermoplastic layer comprising a web of open celled structures formed by a plurality of reinforcing materials bonded together with a thermoplastic material, a second reinforced thermoplastic layer disposed on the second surface of the core layer, the second fiber reinforced thermoplastic layer comprising a web of open celled structures formed by a plurality of reinforcing materials bonded together with a thermoplastic material, and wherein the core layer, the first reinforced thermoplastic layer and the second reinforced thermoplastic layer together provide a vehicle load floor that deflects less than about 25 mm at a weight of no more than 220 kg.

In certain configurations, the vehicle load floor comprises a decorative layer coupled to the first reinforced thermoplastic layer. In some examples, the decorative layer comprises a carpet. In certain instances, the vehicle load floor comprises an adhesive layer between the decorative layer and the first reinforced thermoplastic layer. In other examples, the vehicle load floor comprises a second decorative layer coupled to the second reinforced thermoplastic layer. In some examples, the second decorative layer comprises a carpet. In other examples, the vehicle load floor comprises an adhesive layer between the second decorative layer and the second reinforced thermoplastic layer. In further examples, the vehicle load floor deflects less than 15 mm at 100 kg weight, or less than 15 mm at 150 kg weight, or less than 10 mm at 100 kg weight, or less than 5 mm at 220 kg weight. In some configurations, the thermoplastic material of the first reinforced thermoplastic layer comprises at least one similar or different thermoplastic material than the thermoplastic material present in the second reinforced thermoplastic layer. In other configurations, the closed cell material of the core layer comprises a directionally compressive foam that is selected from the group consisting of a directionally compressive expanded polystyrene foam, a directionally compressive extruded polyethylene foam and a directionally compressive expandable polypropylene foam or, in the alternative, a polyurethane foam or a cellulose based material. In some instances, the thermoplastic material of each of the first fiber reinforced layer and the second fiber reinforced layer is independently selected from the group consisting of a polyolefin material, a thermoplastic polyolefin blend material, a polyvinyl polymer material, a butadiene polymer material, an acrylic polymer material, a polyamide material, a polyester material, a polycarbonate material, a polyestercarbonate material, a polystyrene material, an acrylonitrylstyrene polymer material, an acrylonitrile-butylacrylate-styrene polymer material, a polyether imide material, a polyphenylene ether material, a polyphenylene oxide material, a polyphenylenesulphide material, a polyether material, a polyetherketone material, a polyacetal material, a polyurethane material, a polybenzimidazole material, and copolymers and mixtures thereof. In other configurations, the thermoplastic material in each of the first fiber reinforced layer and the second fiber reinforced layer is independently a resin or a fiber. In some embodiments, the reinforcing materials of each of the first fiber reinforced layer and the second fiber reinforced layer is independently selected from the group consisting of glass fibers, carbon fibers, graphite fibers, synthetic organic fibers, inorganic fibers, natural fibers, mineral fibers, metal fibers, metalized inorganic fibers, metalized synthetic fibers, ceramic fibers, and combinations thereof. In other examples, the fibers present in each of the fiber reinforced first layer and the second fiber reinforced layer comprise a diameter greater than about 5 microns and a length from about 5 mm to about 200 mm. In some examples, the thermoplastic material present in each of the first fiber reinforced layer and the second fiber reinforced layer comprises a polypropylene, and the reinforcing materials present in each of the first fiber reinforced layer and the second fiber reinforced layer are glass fibers. In certain instances, the basis weight of each of the first and second fiber reinforced layers is about 500 gsm to about 3000 gsm and the basis weight of the core layer is about 300 gsm to about 2000 gsm. In some examples, at least one of the first and second fiber reinforced layers comprises a lofting agent. In further examples, the vehicle load floor comprises a carpet layer disposed on at least one of the first fiber reinforced layer and the second fiber reinforced layer. In some embodiments, the first fiber reinforced layer is coupled to the core layer through a first adhesive layer and the second fiber reinforced layer is coupled to the core layer through a second adhesive layer. In other embodiments, the first fiber reinforced layer and the second fiber reinforced layer do not include any lofting agent, and wherein the thermoplastic material and reinforcing materials of the first fiber reinforced layer and the second fiber reinforced layer are each selected to permit lofting of the first fiber reinforced layer and the second fiber reinforced layer in the absence of lofting agent in the first fiber reinforced layer and the second fiber reinforced layer. In some examples, at least one of the core layer, the first reinforced thermoplastic layer and the second reinforced thermoplastic layer comprises a flame retardant material. In certain instances, the flame retardant material comprises one or more of expandable graphite materials, magnesium hydroxide and aluminum hydroxide. If desired, the adhesive layers may also comprise a flame retardant material.

In an additional aspect, a kit for producing a vehicle load floor comprises a core layer and a first reinforced first reinforced thermoplastic layer separate from the core layer, wherein the core layer comprises a closed cell material, the first reinforced thermoplastic layer comprises a web of open celled structures formed by a plurality of reinforcing materials bonded together with a thermoplastic material. The kit may also comprise instructions for coupling the first reinforced thermoplastic core layer to a first surface of the core layer.

In some examples, the kit comprises a second reinforced thermoplastic layer separate from the core layer and first reinforced first reinforced thermoplastic layer. In other examples, the first reinforced thermoplastic layer of the kit is the same as the second reinforced thermoplastic layer of the kit. In some instances, a basis weight of the first reinforced thermoplastic layer of the kit is different than a basis weight of the second reinforced thermoplastic layer of the kit. In other examples, the kit comprises a decorative layer separate from the core layer and the first reinforced thermoplastic layer. In some embodiments, the kit comprises an adhesive material effective to bond the first reinforced thermoplastic layer to the core layer. In some examples, the kit comprises a skin layer. In some instances, the skin layer is selected from the group consisting of a fabric, a scrim, a film and combinations thereof. In other examples, the closed cell material of the core layer comprises a directionally compressive foam that is selected from the group consisting of a directionally compressive expanded polystyrene foam, a directionally compressive extruded polyethylene foam and a directionally compressive expandable polypropylene foam. In certain instances, the core layer is configured as a planar sheet.

In another aspect, a method of forming a multi-layer assembly comprises forming a reinforced thermoplastic layer by combining a thermoplastic polymer, reinforcing fibers and a lofting agent in an aqueous solution, mixing the aqueous solution comprising the thermoplastic polymer, reinforcing fibers and lofting agent to disperse the reinforcing fibers and the lofting agent in the thermoplastic polymer to provide an aqueous foam dispersion, disposing the aqueous foam dispersion onto a forming element, removing liquid from the disposed aqueous foam to provide a reinforced thermoplastic layer comprising a web comprising the thermoplastic polymer, the reinforcing fibers and the lofting agent, and disposing the provided, reinforced thermoplastic layer on a first surface of a core layer comprising a closed cell material. In some examples, at least one of the core layer, the first reinforced thermoplastic layer and the second reinforced thermoplastic layer comprises a flame retardant material. In certain instances, the flame retardant material comprises one or more of expandable graphite materials, magnesium hydroxide and aluminum hydroxide. If desired, the adhesive material may also comprise a flame retardant material.

In certain configurations, the method comprises heating the provided, reinforced thermoplastic layer above a softening temperature of the thermoplastic polymer of the web of the provided, reinforced thermoplastic layer prior to disposing the provided, reinforced thermoplastic layer on the first surface of the core layer. In other instances, the method comprises disposing an adhesive layer on the first surface of the core layer prior to disposing the provided, reinforced thermoplastic layer on the first surface of the core layer. In some examples, the method comprises disposing an adhesive layer on a surface of the provided, reinforced thermoplastic layer prior to disposing the provided, reinforced thermoplastic layer on the first surface of the core layer. In some examples, the method comprises disposing a second adhesive layer on a second surface of the core layer. In other configurations, the method comprises disposing another reinforced thermoplastic layer on the disposed second adhesive layer. In some examples, the method comprises disposing a second adhesive layer on a surface of another reinforced thermoplastic layer. In certain embodiments, the method comprises disposing the another reinforced thermoplastic layer on the core layer to couple the core layer to the another reinforced thermoplastic layer through the second adhesive layer. In other examples, the method comprises heating the provided, reinforced thermoplastic sheet to loft the provided, reinforced thermoplastic sheet. In certain embodiments, the method comprises configuring the core layer to comprise a directionally compressive foam that is selected from the group consisting of a directionally compressive expanded polystyrene foam, a directionally compressive extruded polyethylene foam and a directionally compressive expandable polypropylene foam.

In another aspect, a recreational vehicle wall comprises one or more of the multi-layer assemblies described herein.

In an additional aspect, a recreational vehicle ceiling comprises one or more of the multi-layer assemblies described herein.

In another aspect, a recreational vehicle slide-out assembly, e.g., one comprising a dinette, bathroom or other features in a recreational vehicle, comprises one or more of the multi-layer assemblies described herein. The walls, ceiling, floor or any or all of the structural components of the slide-out assembly may comprise one or more of the multi-layer assemblies described herein.

In an additional aspect, a sleeper cab bunk floor comprises one or more of the multi-layer assemblies described herein.

In another aspect, a sheathing panel comprises one or more of the multi-layer assemblies described herein. For example, roofing panels, floor panels, wall panels, interior or exterior panels used in residential or commercial structures, etc. may comprise one or more of the multi-layer assemblies described herein.

In an additional aspect, a roofing panel comprises one or more of the multi-layer assemblies described herein.

In another aspect, a flooring panel comprises one or more of the multi-layer assemblies described herein.

In an additional aspect, an automotive load floor comprises one or more of the multi-layer assemblies described herein.

In another aspect, a vehicle comprising an automotive load floor comprising one or more of the multi-layer assemblies described herein is described.

In an additional aspect, a vehicle comprising a vehicle load floor as described herein is provided.

In another aspect, a tire cover comprises one or more of the multi-layer assemblies described herein.

In an additional aspect, a deck comprises one or more of the multi-layer assemblies described herein. For example, the deck can be attached to a residential or commercial structure or a recreational vehicle if desired.

Additional features, aspect, examples, configurations and embodiments are described in more detail below.

### BRIEF DESCRIPTION OF THE FIGURES

Certain embodiments are described with reference to the accompanying figures in which:

FIG. 1 is an illustration of a multi-layer assembly comprising a surface layer and a core layer, in accordance with certain examples;

FIG. 2 is an illustration of a multi-layer assembly comprising two surface layers and a core layer, in accordance with certain configurations;

FIG. 3A is an illustration of a multi-layer assembly comprising a core layer, an adhesive layer and a surface layer, in accordance with certain configurations;

FIG. 3B is an illustration showing the assembly of FIG. 3A in combination with a skin or decorative layer, in accordance with certain configurations;

FIG. 4A is an illustration of a multi-layer assembly comprising a core layer, two adhesive layers and two surface layers, in accordance with certain configurations;

FIG. 4B is an illustration showing the assembly of FIG. 4A in combination with a skin or decorative layer, in accordance with certain configurations;

FIG. 5A is an illustration of a multi-layer assembly comprising two core layers and a surface layer, in accordance with certain configurations;

FIG. 5B is an illustration showing the assembly of FIG. 5A in combination with another surface layer;

FIG. 5C is an illustration showing the assembly of FIG. 5B in combination with a skin or decorative layer, in accordance with certain configurations;

FIG. 6A is an illustration of a multi-layer assembly comprising two core layers and two surface layers, in accordance with certain configurations;

FIG. 6B is an illustration showing the assembly of FIG. 6A in combination with another surface layer;

FIG. 6C is an illustration showing the assembly of FIG. 6B in combination with a skin or decorative layer, in accordance with certain configurations;

FIG. 7 is an illustration of a vehicle floor, in accordance with certain examples; and

FIG. 8 is an illustration of a load floor, in accordance with certain configurations.

It will be recognized by the person of ordinary skill in the art, given the benefit of this disclosure, that certain dimensions or features in the figures may have been enlarged, distorted or shown in an otherwise unconventional or non-proportional manner to provide a more user friendly version of the figures. No particular thickness, width or length is intended by the depictions in the figures, and relative sizes of the figure components are not intended to limit the sizes of any of the components in the figures. Where dimensions or values are specified in the description below, the dimensions or values are provided for illustrative purposes only. In addition, no particular material or arrangement is intended to be required by virtue of shading of certain portions of the figures, and even though different components in the figures may include shading for purposes of distinction, the different components can include the same or similar materials, if desired.

### DETAILED DESCRIPTION

Certain embodiments are described below with reference to singular and plural terms in order to provide a more user friendly description of the technology disclosed herein. These terms are used for convenience purposes only and are not intended to limit the layers, assemblies, articles, methods and other subject matter as including or excluding certain features unless otherwise noted as being present in a particular embodiment or excluded from a particular embodiment described herein.

In certain instances, the materials described herein can be used together to provide sheets, panels, floor pans, load floors, vehicle walls, ceilings or floors, e.g., recreational vehicles walls, ceiling or floors and other articles. For example, the multi-layer assembly can be used as a wall or ceiling panel, as flooring, a sub-floor or in automotive applications such as, for example, vehicle load floors or underbody floors of a vehicle. Where the assembly is used as a vehicle load floor, the load floor may be present as an underbody assembly within the vehicle cabin or may be present as or in one or more different components or areas of the vehicle, e.g., as a drawn load floor in a vehicle storage compartment in the rear of a vehicle. In some instances, the multi-layer assembly can be used as a vehicle load floor without any supporting structural support from the vehicle, e.g., the load floor may be constructed and arranged to support a load of a selected weight without the need to provide structural support or reinforcement underneath the load floor. As noted herein, some configurations of the multi-layer assembly may be produced with the use of fiber reinforced thermoplastic surface layers and/or without the use of any fiber reinforced thermoplastic core layer. In other instances, the multi-layer assembly may be produced without the use of any polyurethane core component or without the use of any polyurethane whatsoever. In other configurations, the multi-layer assembly may be produced without the use of any cellulose based materials, e.g., honeycomb, paper, etc. If desired, however, one or more of the layers may comprise a polyurethane, polyurethane foam or cellulose based materials such as, for example, paper, honeycomb, etc.

In some embodiments described herein, the core layer may comprise a directionally compressive material such as a directionally compressive foam. As noted in more detail below, a material which is directionally compressive generally comprises a larger compressive strength in a cross direction than in a machine direction (or vice versa if desired). For example, a core layer may comprise a material with directional compressive strength, e.g., a material with a compressive strength that is different in orthogonal directions, to impart more stiffness to the overall article comprising the core layer. The core layers are typically used with one or more surface layers or skins, which can take many forms. In some examples, the surface layers are non-extruded surface layers to provide for increased porosity and/or to reduce the overall weight of the articles.

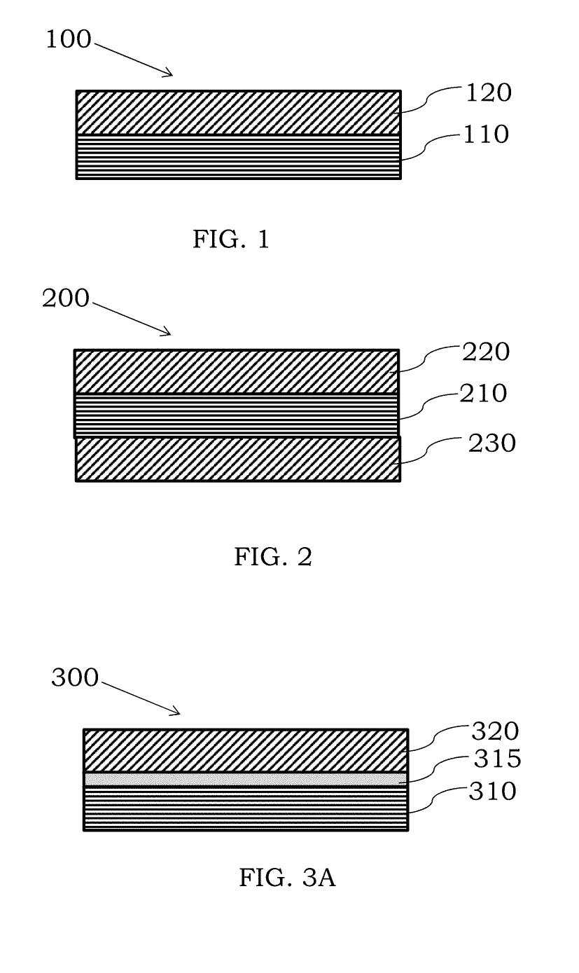

In certain configurations, the multi-layer assembly may comprise two or more different layers coupled to each other. Referring to FIG. 1, a two layer assembly 100 comprises a surface layer 120 coupled to a core layer 110. The surface layer 120 may be configured as a porous, reinforced thermoplastic surface layer as noted in more detail below. The core layer 110 typically is not a porous, reinforced thermoplastic layer and may be a closed cell or substantially non-porous core layer to avoid ingress of water or other fluids. While illustrative core layers are discussed in more detail below, in some configurations the core layer may be a foam such as, for example, a closed-cell foam, a cellulose based product, e.g., a paper honeycomb or other materials. In some configurations, the core layer 110 can be configured as a non-cellulose core layer or a non-polyurethane core layer. The combination of the surface layer 120 and the core layer 110 can provide a lightweight panel or structure that provides sufficient load bearing capabilities to permit its use in floor, walls and ceilings, for example.

In certain embodiments, the reinforced surface layer 120 may be configured as (or used in) a glass mat thermoplastic composite (GMT) or a light weight reinforced thermoplastic (LWRT). One such LWRT is prepared by HANWHA AZDEL, Inc. and sold under the trademark SUPERLITE® mat. The areal density of such a GMT or LWRT can range from about 400 grams per square meter (gsm) of the GMT or LWRT to about 4000 gsm, although the areal density may be less than 400 gsm or greater than 4000 gsm depending on the specific application needs. In some embodiments, the upper density can be less than about 4000 gsm. In certain instances, the GMT or the LWRT may comprise one or more lofting agent materials disposed in void space or pores of the GMT or the LWRT.

In certain examples where an LWRT is used as a surface layer, the LWRT typically includes a thermoplastic material and a plurality of reinforcing fibers which together form a web of open celled structures. For example, the surface layer 120 typically comprises a substantial amount of open cell structure such that void space is present in the layers. In some instances, the surface layer 120 may comprise a void content or porosity of 0-30%, 10-40%, 20-50%, 30-60%, 40-70%, 50-80%, 60-90%, 0-40%,0-50%,0-60%,0-70%,0-80%,0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% or any illustrative value within these exemplary ranges. In some instances, the surface layer 120 comprises a porosity or void content of greater than 0%, e.g., is not fully consolidated, up to about 95%. Unless otherwise stated, the reference to the surface layer comprising a certain void content or porosity is based on the total volume of that surface layer and not necessarily the total volume of the multi-layer assembly.

In certain examples, the surface layer 120 can be produced in the form of a GMT. In certain instances, the GMT can be generally prepared using chopped glass fibers, a thermoplastic material, optionally a lofting agent and an optional thermoplastic polymer film or films and/or woven or non-woven fabrics made with glass fibers or thermoplastic resin fibers such as, for example, polypropylene (PP), polybutylene terephthalate (PBT), polyethylene terephthalate (PET), polycarbonate (PC), a blend of PC/PBT, or a blend of PC/PET. In some embodiments, a PP, a PBT, a PET, a PC/PET blend or a PC/PBT blend can be used as a resin. To produce the glass mat, a thermoplastic material and reinforcing materials can be added or metered into a dispersing foam contained in an open top mixing tank fitted with an impeller. Without wishing to be bound by any particular theory, the presence of trapped pockets of air of the foam can assist in dispersing the glass fibers, the thermoplastic material and the lofting agent. In some examples, the dispersed mixture of fibers and thermoplastic material can be pumped to a head-box located above a wire section of a paper machine via a distribution manifold. The foam, not the fibers and thermoplastic, can then be removed as the dispersed mixture is provided to a moving wire screen using a vacuum, continuously producing a uniform, fibrous wet web. The wet web can be passed through a dryer at a suitable temperature to reduce moisture content and to melt or soften the thermoplastic material.

In certain embodiments, the high porosity present in the surface layer 120 can reduce the overall weight of the layers and can permit the inclusion of agents within the void space. For example, lofting agents can reside in the void space in a non-covalently bonded manner. Application of heat or other perturbations can act to increase the volume of the non-covalently bonded lofting agent which in turn increases the overall thickness of the layer, e.g., the layer increases as the size of the lofting agent increases and/or additional air becomes trapped in the layer. If desired, flame retardants, colorants, smoke suppressants and other materials may be included in the void space of the surface layer 120. Prior to lofting, the surface layer 120 can be compressed to reduce its overall thickness, e.g., compressed before or after the layer is coupled to one or more other layers.

In certain embodiments, the thermoplastic material of the surface layer 120 may comprise, at least in part, one or more of polyethylene, polypropylene, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as copolymers, alloys and blends of these materials with each other or other polymeric materials. The thermoplastic material used to form the layer 120 can be used in powder form, resin form, rosin form, particle form, fiber form or other suitable forms. Illustrative thermoplastic materials in various forms are described herein and are also described, for example in U.S. Publication Nos. 20130244528 and US20120065283. The exact amount of thermoplastic material present in the surface layer 120 can vary and illustrative amounts range from about 20% by weight to about 80% by weight, e.g., 30-70 percent by weight or 35-65 percent by weight.

In certain examples, the reinforcing fibers of the surface layers 120 may comprise glass fibers, carbon fibers, graphite fibers, synthetic organic fibers, particularly high modulus organic fibers such as, for example, para- and meta-aramid fibers, nylon fibers, polyester fibers, or any of the high melt flow index resins described herein that are suitable for use as fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In some embodiments, any of the aforementioned fibers can be chemically treated prior to use to provide desired functional groups or to impart other physical properties to the fibers, e.g., may be chemically treated so that they can react with the thermoplastic material, the lofting agent or both. The fiber content in the layers 120 may independently be from about 20% to about 90% by weight of the layer, more particularly from about 30% to about 70%, by weight of the layer. Typically, the fiber content of a multi-layer assembly comprising the surface layer 120 varies between about 20% to about 90% by weight, more particularly about 30% by weight to about 80% by weight, e.g., about 40% to about 70% by weight of the assembly. The particular size and/or orientation of the fibers used may depend, at least in part, on the thermoplastic polymer material used and/or the desired properties of the surface layer 120. Suitable additional types of fibers, fiber sizes and amounts will be readily selected by the person of ordinary skill in the art, given the benefit of this disclosure. In one non-limiting illustration, fibers dispersed within a thermoplastic material and optionally a lofting agent to provide a surface layer 120 can generally have a diameter of greater than about 5 microns, more particularly from about 5 microns to about 22 microns, and a length of from about 5 mm to about 200 mm; more particularly, the fiber diameter may be from about microns to about 22 microns and the fiber length may be from about 5 mm to about 75 mm.

In some embodiments, the lofting capacity of the surface layer 120 can be further tuned by including one or more added lofting agents. The exact type of lofting agent used in the layer 120 can depend on numerous factors including, for example, the desired lofting temperature, the desired degree of loft, etc. In some instances, microsphere lofting agents, e.g., expandable microspheres, which can increase their size upon exposure to convection heating may be used. Illustrative commercially available lofting agents are available from Kureha Corp. (Japan). In other instances, a first lofting agent with a first average particle size and a second lofting agent with a second average particle size, different from the first average particle size, may be used in the layer 120. In other examples, the lofting agent may be an expandable graphite material.

In some examples, the core layer 110 may comprise a closed cell foam or other materials which are not a porous fiber reinforced thermoplastic layer, e.g., the closed cell foam may comprise a porosity of less than about 5%, 4%, 3%, 2% or 1%. In some embodiments, the core layer is not a sprayed or sprayable core layer but is instead a solid, planar layer which can be coupled to the surface layer 120 post-formation of the core layer 110. In some examples, the core layer 110 may comprise one or more of a foam, a cardboard, or a paper honeycomb or combinations thereof. In other examples, the core layer 110 may comprise or be a polystyrene foam, an expanded or extruded polyolefin foam (e.g., extruded polyethylene or expanded polypropylene) or other foams. In some instances, the core layer may lack any polyurethane materials and/or may lack any cellulose materials. Without wishing to be bound by any particular theory, the presence of certain materials such as polyurethane and/or cellulose can result in deformed edges and/or permit mold growth if moisture penetrates into the core layer. By using foam core layers of certain materials, a clean edge may exist, mold growth problems can be avoided and higher compressive strength may be obtained at lighter areal weights. Illustrative basis weights for the core layer 110 include, but are not limited to, about 300 gsm to about 2000 gsm, more particularly about 500 gsm to about 1900 gsm or about 500 gsm to about 1500 gsm.

In some embodiments, the core layer 110 may comprise a foam with a larger compressive strength in a cross direction than in a machine direction. For example, the core layer 110 may comprise a foam with directional compressive strength, e.g., one with a compressive strength that is different in orthogonal directions, to impart more stiffness to the overall article comprising the core layer 110 and the surface layer 120. Foams which can provide directional compressive strength are commercially available from Dow Corning and other suppliers. The core layer 110 is typically first formed from the foam (or other material) and then coupled to the surface layer 120. In some configurations, the material of the core layer 110 can be constructed and arranged to permit compression of the core layer 110 without substantial damage to the core layer 110. Materials in the core layer 110 can also be selected to permit the article 100 to be thermoformed, e.g., compressed, molded, etc., without substantial damage to the core layer 110. Compared to fiber thermoplastic core layers, at comparable basis weights the presence of a core layer 110 comprising a closed cell foam (or non-fiber reinforced thermoplastic materials) can provide better performance and higher strength.

In some configurations, the surface layer 120 (and optionally the core layer 110) may be a substantially halogen free or halogen free layer to meet the restrictions on hazardous substances requirements for certain applications. In other instances, one or more of the layers 110, 120 may comprise a halogenated flame retardant agent such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo-polycarbonates. In some instances, the thermoplastic material used in the surface layer 120 may comprise one or more halogens to impart some flame retardancy without the addition of another flame retardant agent. Where halogenated flame retardants are present, the flame retardant is desirably present in a flame retardant amount, which can vary depending on the other components which are present. For example, the halogenated flame retardant may be present in about 0.1 weight percent to about 15 weight percent (based on the weight of the layer), more particularly about 1 weight percent to about 13 weight percent, e.g., about 5 weight percent to about 13 weight percent. If desired, two different halogenated flame retardants may be added to the layers. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the layers may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the layer), more particularly about 1 weight percent to about 13 weight percent, e.g., about 5 weight percent to about 13 weight percent based on the weight of the layer. If desired, two different substantially halogen free flame retardants may be added to one or more of the layers 110, 120. In certain instances, one or more of the layers 110, 120 described herein may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present may be about 0.1 weight percent to about 20 weight percent (based on the weight of the layer), more particularly about 1 weight percent to about 15 weight percent, e.g., about 2 weight percent to about 14 weight percent based on the weight of the layer. The flame retardant agents used in the layers described herein can be added to the mixture comprising the thermoplastic material and fibers (prior to disposal of the mixture on a wire screen or other processing component) or can be added after the layer is formed. In some examples, the flame retardant material may comprise one or more of expandable graphite materials, magnesium hydroxide (MDH) and aluminum hydroxide (ATH).

In certain configurations and referring to FIG. 2, a multi-layer assembly 200 may comprise a surface layer 220, 230 on each surface of a core layer 210. The surface layers 220, 230 can be the same or they can be different. In certain instances, the surface layers 220, 230 may generally comprise the same materials but may have different amounts of the materials, e.g., different amounts of reinforcing fibers and/or different amounts of thermoplastic materials. In other examples, the surface layers 220, 230 may comprise the same thermoplastic material but different reinforcing fibers. In additional configurations, the surface layers 220, 230 may comprise the same reinforcing fibers but different thermoplastic materials. In other instances, the surface layers 220, 230 may comprise the same reinforcing materials and thermoplastic materials but have a different basis weight, a different porosity or other different physical properties. In some examples, the surface layers 220, 230 may comprise the same reinforcing fibers and same thermoplastic materials but have a different thickness or a different amount of a lofting agent to provide for variable lofting capacities.

In certain examples, each of the surface layers 220, 230 may independently be configured similar to the surface layer 120, e.g., each of the surface layers 220, 230 may be a GMT or LWRT. For example, each of the surface layers 220, 230 may be configured as a LWRT comprising one or more thermoplastic materials. In some examples, the thermoplastic material present in each of the layers 220, 230 may independently comprise, at least in part, one or more of polyethylene, polypropylene, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate- styrene polymers, amorphous nylon, polyarylene ether ketone, polyphenylene sulfide, polyaryl sulfone, polyether sulfone, liquid crystalline polymers, poly(l,4-phenylene) compounds commercially known as PARMAX®, high heat polycarbonate such as Bayer's APEC® PC, high temperature nylon, and silicones, as well as copolymers, alloys and blends of these materials with each other or other polymeric materials. The thermoplastic material used to form the layers 220, 230 can be used in powder form, resin form, rosin form, particle form, fiber form or other suitable forms, and the form used in the different layers 220, 230 need not be the same. Illustrative thermoplastic materials in various forms are described herein and are also described, for example in U.S. Publication Nos. 20130244528 and US20120065283. The exact amount of thermoplastic material present in the surface layers 220, 230 can vary and illustrative amounts range from about 20% by weight to about 80% by weight, e.g., 30-70 percent by weight or 35-65 percent by weight. As noted herein, the amount of thermoplastic material present in the surface layers 220, 230 need not be the same

In certain examples, the reinforcing fibers of the surface layers 220, 230 may independently comprise glass fibers, carbon fibers, graphite fibers, synthetic organic fibers, particularly high modulus organic fibers such as, for example, para- and meta-aramid fibers, nylon fibers, polyester fibers, or any of the high melt flow index resins described herein that are suitable for use as fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In some embodiments, any of the aforementioned fibers can be chemically treated prior to use to provide desired functional groups or to impart other physical properties to the fibers, e.g., may be chemically treated so that they can react with the thermoplastic material, the lofting agent or both. In some instances, fibers in one of the surface layers 220, 230 are chemically treated and fibers in the other one of the surface layers 220, 230 are not chemically treated. The fiber content in each of the layers 220, 230 may independently be from about 20% to about 90% by weight of the layer, more particularly from about 30% to about 70%, by weight of the layer. Typically, the fiber content of a multi-layer assembly comprising the surface layers 220, 230 varies between about 20% to about 90% by weight, more particularly about 30% by weight to about 80% by weight, e.g., about 40% to about 70% by weight of the assembly. The particular size and/or orientation of the fibers used may depend, at least in part, on the thermoplastic polymer material used and/or the desired properties of the surface layers 220, 230. Suitable additional types of fibers, fiber sizes and amounts will be readily selected by the person of ordinary skill in the art, given the benefit of this disclosure. In one non-limiting illustration, fibers dispersed within a thermoplastic material and optionally a lofting agent to provide the surface layers 220, 230 can generally have a diameter of greater than about 5 microns, more particularly from about 5 microns to about 22 microns, and a length of from about 5 mm to about 200 mm, more particularly, the fiber diameter may be from about microns to about 22 microns and the fiber length may be from about 5 mm to about 75 mm.

In certain embodiments, the surface layers 220, 230 may comprise a different fiber material or a different fiber loading. Where different fiber materials are present, the fibers may be different fibers entirely, e.g., glass fibers in one layer and carbon fibers in another layer, or may comprise the same base material that has been modified, e.g., glass fibers in one layer and chemically treated glass fibers in another layer. In some instances, the fibers may be the same fiber material but one or more physical properties of the fibers may differ. For example, the fibers of the layer 220 may have a first diameter that differs from a diameter of the fibers present in the layer 230 even though the fiber material in the layers 220, 230 may be the same or different. In other instances, the length of the fibers in the layer 220 may differ from a length of the fibers present in the layer 230 even though the fiber material present in the layers 220, 230 may be the same or different. In additional examples, both the length and diameter of the fiber in the layer 220 may differ from a length and diameter of the fibers in the layer 230 even though the fiber material present in the layers 220, 230 may be the same or different. In yet other examples, two or more different fibers may be used in one of the layers 220, 230 and a single type of fibers may be present in the other layer. As noted herein, by selecting the amount and/or type of fibers, it is possible to vary the physical properties of the surface layers 220, 230, e.g., to provide a different lofting capacity for different surface layers of the assembly.

In some examples, the core layer 210 may comprise a closed cell foam or other materials which are not a fiber reinforced thermoplastic layer e.g., the closed cell foam of the core layer 210 may comprise a porosity of less than about 5%, 4%, 3%, 2% or 1%. In some embodiments, the core layer is not a sprayed or sprayable core layer but is instead a solid, planar layer which can be coupled to the surface layers 220, 230 post-formation of the core layer 210. In some examples, the core layer 210 may comprise one or more of a foam, a cardboard, or a paper honeycomb or combinations thereof. In other examples, the core layer 210 may comprise or be a polystyrene foam, an expanded or extruded polyolefin foam (e.g., extruded polyethylene or expanded polypropylene) or other foams. In some instances, the core layer may lack any polyurethane materials and/or may lack any cellulose materials. By using certain foam materials in the core layer 210, a clean edge may exist, mold growth problems can be avoided and higher compressive strength may be obtained at lighter areal weights. Illustrative basis weights for the core layer 210 include, but are not limited to, about 300 gsm to about 2000 gsm, more particularly about 500 gsm to about 1900 gsm or about 500 gsm to about 1500 gsm

In some embodiments, the core layer 210 may comprise a foam with a larger compressive strength in a cross direction than in a machine direction. For example, the core layer 210 may comprise a foam with directional compressive strength, e.g., one with a compressive strength that is different in orthogonal directions, to impart more stiffness to the overall article comprising the core layer 210 and the surface layers 220, 230. Foams which can provide directional compressive strength are commercially available from Dow Corning and other suppliers. The core layer 210 is typically first formed from the foam (or other material) and then coupled to the surface layers 220, 230. In some configurations, the material of the core layer 210 can be constructed and arranged to permit compression of the core layer 210 without substantial damage to the core layer 210. Materials in the core layer 210 can also be selected to permit the article 200 to be thermoformed, e.g., compressed, molded, etc., without substantial damage to the core layer 210. Compared to fiber thermoplastic core layers, at comparable basis weights the presence of a core layer 210 comprising a closed cell foam (or non-fiber reinforced thermoplastic materials) can provide better performance and higher strength.

In some configurations, the surface layers 220, 230 (and optionally the core layer 210) may be a substantially halogen free or halogen free layer to meet the restrictions on hazardous substances requirements for certain applications. In other instances, one or more of the layers 210, 220, 230 may comprise a halogenated flame retardant agent such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo- polycarbonates. In some instances, the thermoplastic material used in one or more of the surface layers 220, 230 may comprise one or more halogens to impart some flame retardancy without the addition of another flame retardant agent. Where halogenated flame retardants are present, the flame retardant is desirably present in a flame retardant amount, which can vary depending on the other components which are present. For example, the halogenated flame retardant may be present in about 0.1 weight percent to about 15 weight percent (based on the weight of the layer), more particularly about 1 weight percent to about 13 weight percent, e.g., about 5 weight percent to about 13 weight percent. If desired, two different halogenated flame retardants may be added to the layers. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the layers may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the layer), more particularly about 1 weight percent to about 13 weight percent, e.g., about 5 weight percent to about 13 weight percent based on the weight of the layer. If desired, two different substantially halogen free flame retardants may be added to one or more of the layers 210, 220, and 230. In certain instances, one or more of the layers 210, 220 and 230 may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present may be about 0.1 weight percent to about 20 weight percent (based on the weight of the layer), more particularly about 1 weight percent to about 15 weight percent, e.g., about 2 weight percent to about 14 weight percent based on the weight of the layer. The flame retardant agents used in the layers described herein can be added to the mixture comprising the thermoplastic material and fibers (prior to disposal of the mixture on a wire screen or other processing component) or can be added after the layer is formed. In some examples, the flame retardant material may comprise one or more of expandable graphite materials, magnesium hydroxide (MDH) and aluminum hydroxide (ATH).

In the configuration shown in FIG. 2, the lofting capacity of the surface layers 220, 230 can be further tuned by including one or more added lofting agents. The exact type of lofting agent used in the layers 220, 230 can depend on numerous factors including, for example, the desired lofting temperature, the desired degree of loft, etc. In some instances, microsphere lofting agents, e.g., expandable microspheres, which can increase their size upon exposure to convection heating may be used. Illustrative commercially available lofting agents are available from Kureha Corp. (Japan). In other instances, a first lofting agent with a first average particle size and a second lofting agent with a second average particle size, different from the first average particle size, may be used. In other examples, the lofting agent may be an expandable graphite material. The surface layers 220, 230 can be configured to provide the same lofting capacity or different lofting capacities. For example, upon exposure to heat or other lofting stimulus, the post-loft thickness of the layer 220 can be greater than that of the layer 230. For example, the thickness of the layer 220 prior to lofting may be about 1-2 mm and after lofting may be about 10-15 mm. The thickness of the layers 220, 230 prior to lofting may also be about 1-2 mm and after lofting may be about 6-8 mm. These thickness changes may occur even in the absence of any added lofting agent. For example and without wishing to be bound by any particular theory, during lofting the thermoplastic material may melt and release its hold on the reinforcing materials to permit the reinforcing materials to occupy more volume. Subsequent cooling of the thermoplastic material can result in reformation of a web of open celled structures with a larger volume than the pre-lofted web. By tuning the level of thermoplastic material and/or reinforcing materials in the layer 220 the degree to which the volume of the layer 220 can increase may be selected. In comparison, the amount of thermoplastic material and/or reinforcing materials present in the layer 230 can be selected such that melting of the thermoplastic material during lofting does not result in a substantial increase in the overall volume. As the web of the layer 230 reforms after lofting, the resulting post-lofted web volume is not substantially different from the pre-lofted web volume. If desired, one or more of the layers 220, 230 may include an added lofting agent to further increase the overall volume. For example, the layer 220 may comprise an added lofting agent to further select the overall post-lofted volume. In some instances, enough lofting agent is present so the post-lofted layer 220 (and/or the post-lofted layer 230) has a thickness of about 20-25 mm. In some examples, the layer 220 may comprise a polyolefin, reinforcing fibers and a lofting agent, and the layer 230 may comprise a polyolefin (which can be the same or different than the polyolefin in the layer 220) and a reinforcing material. In certain configurations, the polyolefin present in each of the layers 220, 230 may be polypropylene or a polyolefin copolymer comprising polypropylene. In some embodiments, the reinforcing material of each of the layers 220, 230 may comprise glass fibers optionally in combination with other fibers. The exact weight percentages of the thermoplastic material and reinforcing materials in each of the layers 220, 230 may vary, and illustrative weight percentages in the layers 220, 230 are about 40-60 weight percent thermoplastic material with the balance being reinforcing material. If desired, the surface layer 230 can be configured so it has a higher lofting capacity than the layer 220.

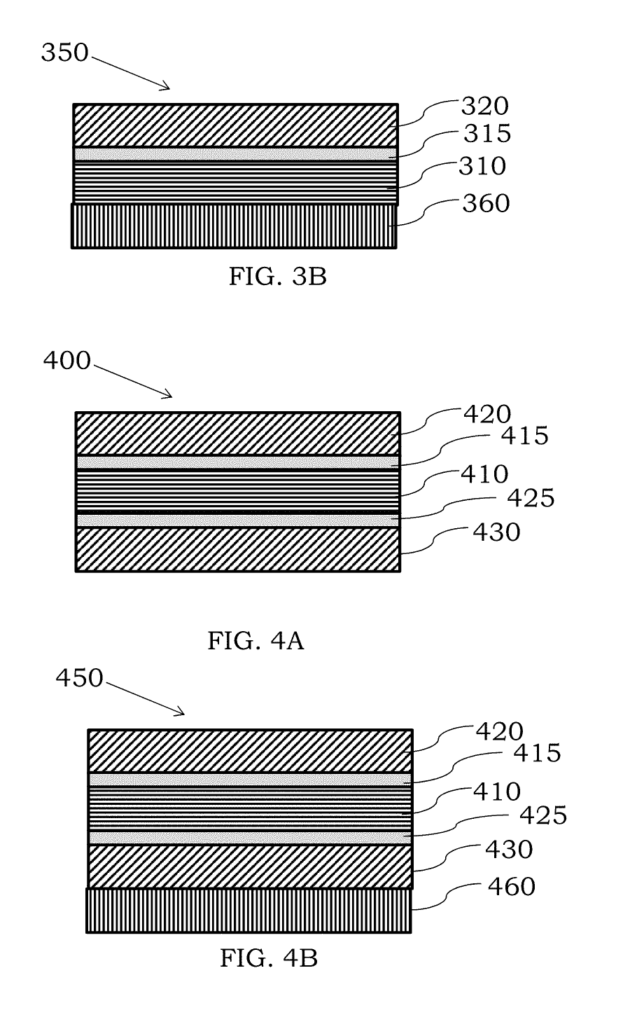

Several different illustrative layer assemblies are now described to illustrate further some of the possible configurations of a multi-layer assembly comprising a reinforced thermoplastic surface layer in combination with one or more core layers. Additional configurations will be recognized by the person of ordinary skill in the art, given the benefit of this disclosure. Referring to FIG. 3A, a composite article 300 is shown comprising a core layer 310 and a surface layer 320 coupled to each other through an adhesive layer 315. The surface layer 320 may be configured similar to any of the surface layers 120, 220 or 230, e.g. may be a porous fiber reinforced thermoplastic layer such as a GMT or a LWRT. While not shown, an additional surface layer can be coupled to an opposite surface of the core layer 310.

In certain examples, the surface layer 320 may comprise or may be configured as (or used in) a glass mat thermoplastic composite (GMT) or a light weight reinforced thermoplastic (LWRT). The areal density of such a GMT or LWRT can range from about 400 grams per square meter (gsm) of the GMT or LWRT to about 4000 gsm, although the areal density may be less than 400 gsm or greater than 4000 gsm depending on the specific application needs. In some embodiments, the upper density can be less than about 4000 gsm. In certain instances, the GMT or the LWRT may comprise one or more lofting agent materials disposed in void space or pores of the GMT or the LWRT. In certain examples where an LWRT is used as a surface layer 320, the LWRT typically includes a thermoplastic material and a plurality of reinforcing fibers which together form a web of open celled structures. For example, the surface layer 320 typically comprises a substantial amount of open cell structure such that void space is present in the layers. In some instances, the surface layer 320 may comprise a void content or porosity of 0-30%, 10-40%, 20-50%, 30-60%, 40-70%, 50-80%, 60-90%, 0-40%,0-50%,0-60%,0-70%,0-80%,0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% or any illustrative value within these exemplary ranges. In some instances, the surface layer 320 comprises a porosity or void content of greater than 0%, e.g., is not fully consolidated, up to about 95%. Unless otherwise stated, the reference to the surface layer comprising a certain void content or porosity is based on the total volume of that surface layer and not necessarily the total volume of the multi-layer assembly.

In certain examples, the surface layer 320 can be produced in the form of a GMT. In certain instances, the GMT can be generally prepared using chopped glass fibers, a thermoplastic material, optionally a lofting agent and an optional thermoplastic polymer film or films and/or woven or non-woven fabrics made with glass fibers or thermoplastic resin fibers such as, for example, polypropylene (PP), polybutylene terephthalate (PBT), polyethylene terephthalate (PET), polycarbonate (PC), a blend of PC/PBT, or a blend of PC/PET. In some embodiments, a PP, a PBT, a PET, a PC/PET blend or a PC/PBT blend can be used as a resin. To produce the glass mat, a thermoplastic material and reinforcing materials can be added or metered into a dispersing foam contained in an open top mixing tank fitted with an impeller. Without wishing to be bound by any particular theory, the presence of trapped pockets of air of the foam can assist in dispersing the glass fibers, the thermoplastic material and the lofting agent. In some examples, the dispersed mixture of fibers and thermoplastic material can be pumped to a head-box located above a wire section of a paper machine via a distribution manifold. The foam, not the fibers and thermoplastic, can then be removed as the dispersed mixture is provided to a moving wire screen using a vacuum, continuously producing a uniform, fibrous wet web. The wet web can be passed through a dryer at a suitable temperature to reduce moisture content and to melt or soften the thermoplastic material.

In certain embodiments, the high porosity present in the surface layer 320 can reduce the overall weight of the article 300 and can permit the inclusion of agents within the void space. For example, lofting agents can reside in the void space in a non-covalently bonded manner. Application of heat or other perturbations can act to increase the volume of the non-covalently bonded lofting agent which in turn increases the overall thickness of the layer, e.g., the layer increases as the size of the lofting agent increases and/or additional air becomes trapped in the layer. If desired, flame retardants, colorants, smoke suppressants and other materials may be included in the void space of the surface layer 320. Prior to lofting, the surface layer 320 can be compressed to reduce its overall thickness, e.g., compressed before or after the layer is coupled to one or more other layers.

In certain embodiments, the thermoplastic material of the surface layer 320 may comprise, at least in part, one or more of polyethylene, polypropylene, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(l,4-phenylene) compounds commercially known as PARMAX®, high heat polycarbonate such as Bayer's APEC® PC, high temperature nylon, and silicones, as well as copolymers, alloys and blends of these materials with each other or other polymeric materials. The thermoplastic material used to form the layer 320 can be used in powder form, resin form, rosin form, particle form, fiber form or other suitable forms. Illustrative thermoplastic materials in various forms are described herein and are also described, for example in U.S. Publication Nos. 20130244528 and US20120065283. The exact amount of thermoplastic material present in the surface layer 320 can vary and illustrative amounts range from about 20% by weight to about 80% by weight, e.g., 30-70 percent by weight or 35-65 percent by weight.

In certain examples, the reinforcing fibers of the surface layers 320 may comprise glass fibers, carbon fibers, graphite fibers, synthetic organic fibers, particularly high modulus organic fibers such as, for example, para- and meta-aramid fibers, nylon fibers, polyester fibers, or any of the high melt flow index resins described herein that are suitable for use as fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In some embodiments, any of the aforementioned fibers can be chemically treated prior to use to provide desired functional groups or to impart other physical properties to the fibers, e.g., may be chemically treated so that they can react with the thermoplastic material, the lofting agent or both. The fiber content in the layer 320 may independently be from about 20% to about 90% by weight of the layer, more particularly from about 30% to about 70%, by weight of the layer. Typically, the fiber content of a multi-layer assembly comprising the surface layer 320 varies between about 20% to about 90% by weight, more particularly about 30% by weight to about 80% by weight, e.g., about 40% to about 70% by weight of the assembly. The particular size and/or orientation of the fibers used may depend, at least in part, on the thermoplastic polymer material used and/or the desired properties of the surface layer 320. Suitable additional types of fibers, fiber sizes and amounts will be readily selected by the person of ordinary skill in the art, given the benefit of this disclosure. In one non-limiting illustration, fibers dispersed within a thermoplastic material and optionally a lofting agent to provide a surface layer 320 can generally have a diameter of greater than about 5 microns, more particularly from about 5 microns to about 22 microns, and a length of from about 5 mm to about 200 mm, more particularly, the fiber diameter may be from about microns to about 22 microns and the fiber length may be from about 5 mm to about 75 mm.

In some embodiments, the lofting capacity of the surface layer 320 can be further tuned by including one or more added lofting agents. The exact type of lofting agent used in the layer 320 can depend on numerous factors including, for example, the desired lofting temperature, the desired degree of loft, etc. In some instances, microsphere lofting agents, e.g., expandable microspheres, which can increase their size upon exposure to convection heating may be used. Illustrative commercially available lofting agents are available from Kureha Corp. (Japan). In other instances, a first lofting agent with a first average particle size and a second lofting agent with a second average particle size, different from the first average particle size, may be used in the layer 320. In other examples, the lofting agent may be an expandable graphite material.

In certain examples, the core layer 310 may be configured similar to the core layers 110, 210 described herein, e.g., may not be a porous, fiber reinforced thermoplastic layer or may be a closed cell foam. In certain configurations, the core layer 310 may comprise a closed cell foam or other materials which are not a fiber reinforced thermoplastic layer e.g., the closed cell foam of the core layer 310 may comprise a porosity of less than about 5%, 4%, 3%, 2% or 1%. In some embodiments, the core layer is not a sprayed or sprayable core layer but is instead a solid, planar layer which can be coupled to the adhesive layer 315 post-formation of the core layer 310, e.g., the adhesive layer 315 can be disposed or otherwise added to a surface of the core layer 310 post-formation of the core layer. In some examples, the core layer 310 may comprise one or more of a foam, a cardboard, or a paper honeycomb or combinations thereof. In other examples, the core layer 310 may comprise or be a polystyrene foam, an expanded or extruded polyolefin foam (e.g., extruded polyethylene or expanded polypropylene) or other foams. In some instances, the core layer may lack any polyurethane materials and/or may lack any cellulose materials. By using certain foam materials in the core layer 310, a clean edge may exist, mold growth problems can be avoided and higher compressive strength may be obtained at lighter areal weights. Illustrative basis weights for the core layer 310 include, but are not limited to, about 300 gsm to about 2000 gsm, more particularly about 500 gsm to about 1900 gsm or about 500 gsm to about 1500 gsm

In some embodiments, the core layer 310 may comprise a foam with a larger compressive strength in a cross direction than in a machine direction. For example, the core layer 310 may comprise a foam with directional compressive strength, e.g., one with a compressive strength that is different in orthogonal directions, to impart more stiffness to the overall article comprising the core layer 210 and the surface layer 320. Foams which can provide directional compressive strength are commercially available from Dow Corning and other suppliers. The core layer 310 is typically first formed from the foam (or other material) and then coupled to the surface layer 320 through the adhesive layer 315. In some configurations, the material of the core layer 310 can be constructed and arranged to permit compression of the core layer 310 without substantial damage to the core layer 310. Materials in the core layer 310 can also be selected to permit the article 300 to be thermoformed, e.g., compressed, molded, etc., without substantial damage to the core layer 310. Compared to fiber thermoplastic core layers, at comparable basis weights the presence of a core layer 310 comprising a closed cell foam (or non-fiber reinforced thermoplastic materials) can provide better performance and higher strength.

In some configurations, the adhesive layer 315 can act to couple the surface layer 320 to the underlying core layer 310 to prevent separation of the surface layer 320 from the core layer 310. Suitable adhesives include, but are not limited to, thermoplastic adhesives including, but not limited to, pressure sensitive adhesives and hot melt adhesives, such as polyamides, modified polyolefins, urethanes and polyolefins. In some examples, the thermoplastic component of the adhesive layer 315 may comprise a thermoplastic polymer such as, for example, a polyolefin such as a polyethylene or a polypropylene. In other instances, the thermoplastic polymer of the adhesive layer may comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layer 315 include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4-phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive layer 315 may also comprise some thermosetting material including, but not limited to, epoxides, epoxy resins, polyesters, polyester resins, urethanes, polyurethanes, diallyl-phthalates, polymides, cyanate esters, polycyanurates and combinations thereof.

In certain configurations, the core layer 310 can be coupled to an additional layer at an opposite surface. Referring to FIG. 3B, an article 350 is shown as comprising the core layer 310 coupled to the surface layer 320 through an adhesive layer 315. An opposite surface of the core layer 310 is coupled to a layer 360. The layer 360 can take numerous forms and is typically different from the surface layer 320, e.g., may not be a fiber reinforced thermoplastic layer. In some embodiments, the layer 360 may take the form of a skin. The skin 360 may comprise, for example, a film (e.g., thermoplastic film or elastomeric film), a frim, a scrim (e.g., fiber based scrim), a foil, a woven fabric, a non-woven fabric or be present as an inorganic coating, an organic coating, or a thermoset coating. In other instances, the skin 360 may comprise a limiting oxygen index greater than about 22, as measured per ISO 4589 dated 1996. Where a thermoplastic film is present as (or as part of) the skin 360, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present as (or as part of) the skin 360, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as (or as part of) the skin 360, the coating may comprise at least one of unsaturated polyurethanes, vinyl esters, phenolics and epoxies. Where an inorganic coating is present as (or as part of) the skin 360, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the skin 360, the non-woven fabric may comprise a thermoplastic material, a thermal setting binder, inorganic fibers, metal fibers, metallized inorganic fibers and metallized synthetic fibers. If desired, the skin 360 may also comprise a lofting agent as well.

In certain instances, the layer 360 may be configured as a decorative layer. The decorative layer 360 may be formed, e.g., from a thermoplastic film of polyvinyl chloride, polyolefins, thermoplastic polyesters, thermoplastic elastomers, or the like. The decorative layer 360 may comprise a carpet, rubber or other aesthetic covering. The decorative layer 360 may also be a multi-layered structure that includes a foam core formed from, e.g., polypropylene, polyethylene, polyvinyl chloride, polyurethane, and the like. A fabric may be bonded to the foam core, such as woven fabrics made from natural and synthetic fibers, organic fiber non-woven fabric after needle punching or the like, raised fabric, knitted goods, flocked fabric, or other such materials. The fabric may also be bonded to the foam core with a thermoplastic adhesive, including pressure sensitive adhesives and hot melt adhesives, such as polyamides, modified polyolefins, urethanes and polyolefins. The decorative layer 360 may also be produced using spunbond, thermal bonded, spun lace, melt-blown, wet-laid, and/or dry-laid processes. While not shown, a skin, e.g., scrim, film, decorative layer, etc. can also be coupled to the layer 320 if desired.

In certain configurations and referring to FIGS. 4A and 4B, a multi-layer assembly 400 (or 450 in FIG. 4B) may comprise a surface layer 420, 430 on each surface of a core layer 410. The surface layers 420, 430 can be the same or they can be different. In certain instances, the surface layers 420, 430 may generally comprise the same materials but may have different amounts of the materials, e.g., different amounts of reinforcing fibers and/or different amounts of thermoplastic materials. In other examples, the surface layers 420, 430 may comprise the same thermoplastic material but different reinforcing fibers. In additional configurations, the surface layers 420, 430 may comprise the same reinforcing fibers but different thermoplastic materials. In other instances, the surface layers 420, 430 may comprise the same reinforcing materials and thermoplastic materials but have a different basis weight, a different porosity or other different physical properties. In some examples, the surface layers 420, 430 may comprise the same reinforcing fibers and same thermoplastic materials but have a different thickness or a different amount of a lofting agent to provide for variable lofting capacities.

In certain configurations, the surface layer 420 is coupled to the core layer 410 through an adhesive layer 415, and the surface layer 430 is coupled to the core layer 410 through an adhesive layer 425. The adhesive layers 415, 425 can act to couple the surface layers 420, 430, respectively, to the underlying core layer 410 to prevent separation of the surface layers 420, 430 from the core layer 410. The adhesive layers 415, 425 need not have the same materials, thickness, etc. Illustrative adhesives that can independently be included in the adhesive layers 415, 425 include, but are not limited to, thermoplastic adhesives including, but not limited to, pressure sensitive adhesives and hot melt adhesives, such as polyamides, modified polyolefins, urethanes and polyolefins. In some examples, the thermoplastic component of the adhesive layers 415, 425 may independently comprise a thermoplastic polymer such as, for example, a polyolefin such as a polyethylene or a polypropylene. In other instances, the thermoplastic polymer of the adhesive layers 415, 425 may independently comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layers 415, 425 include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive layers 415, 425 may also independently comprise some thermosetting material including, but not limited to, epoxides, epoxy resins, polyesters, polyester resins, urethanes, polyurethanes, diallyl-phthalates, polymides, cyanate esters, polycyanurates and combinations thereof.

In certain examples, each of the surface layers 420, 430 may independently be configured similar to the surface layer 120, e.g., each of the surface layers 420, 430 may be a GMT or LWRT. For example, each of the surface layers 420, 430 may be configured as a LWRT comprising one or more thermoplastic materials. In some examples, the thermoplastic material present in each of the layers 420, 430 may independently comprise, at least in part, one or more of polyethylene, polypropylene, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate- styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as copolymers, alloys and blends of these materials with each other or other polymeric materials. The thermoplastic material used to form the layers 420, 430 can be used in powder form, resin form, rosin form, particle form, fiber form or other suitable forms, and the form used in the different layers 420, 430 need not be the same. Illustrative thermoplastic materials in various forms are described herein and are also described, for example in U.S. Publication Nos. 20130244528 and US20120065283. The exact amount of thermoplastic material present in the surface layers 420, 430 can vary and illustrative amounts range from about 20% by weight to about 80% by weight, e.g., 30-70 percent by weight or 35-65 percent by weight. As noted herein, the amount of thermoplastic material present in the surface layers 420, 430 need not be the same

In certain examples, the reinforcing fibers of the surface layers 420, 430 may independently comprise glass fibers, carbon fibers, graphite fibers, synthetic organic fibers, particularly high modulus organic fibers such as, for example, para- and meta-aramid fibers, nylon fibers, polyester fibers, or any of the high melt flow index resins described herein that are suitable for use as fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In some embodiments, any of the aforementioned fibers can be chemically treated prior to use to provide desired functional groups or to impart other physical properties to the fibers, e.g., may be chemically treated so that they can react with the thermoplastic material, the lofting agent or both. In some instances, fibers in one of the surface layers 420, 430 are chemically treated and fibers in the other one of the surface layers 420, 430 are not chemically treated. The fiber content in each of the layers 420, 430 may independently be from about 20% to about 90% by weight of the layer, more particularly from about 30% to about 70%, by weight of the layer. Typically, the fiber content of a multi-layer assembly comprising the surface layers 420, 430 varies between about 20% to about 90% by weight, more particularly about 30% by weight to about 80% by weight, e.g., about 40% to about 70% by weight of the assembly. The particular size and/or orientation of the fibers used may depend, at least in part, on the thermoplastic polymer material used and/or the desired properties of the surface layers 420, 430. Suitable additional types of fibers, fiber sizes and amounts will be readily selected by the person of ordinary skill in the art, given the benefit of this disclosure. In one non-limiting illustration, fibers dispersed within a thermoplastic material and optionally a lofting agent to provide the surface layers 420, 430 can generally have a diameter of greater than about 5 microns, more particularly from about 5 microns to about 22 microns, and a length of from about 5 mm to about 200 mm, more particularly, the fiber diameter may be from about microns to about 22 microns and the fiber length may be from about 5 mm to about 75 mm.

In certain embodiments, the surface layers 420, 430 may comprise a different fiber material or a different fiber loading. Where different fiber materials are present, the fibers may be different fibers entirely, e.g., glass fibers in one layer and carbon fibers in another layer, or may comprise the same base material that has been modified, e.g., glass fibers in one layer and chemically treated glass fibers in another layer. In some instances, the fibers may be the same fiber material but one or more physical properties of the fibers may differ. For example, the fibers of the layer 420 may have a first diameter that differs from a diameter of the fibers present in the layer 430 even though the fiber material in the layers 420, 430 may be the same or different. In other instances, the length of the fibers in the layer 420 may differ from a length of the fibers present in the layer 430 even though the fiber material present in the layers 420, 430 may be the same or different. In additional examples, both the length and diameter of the fiber in the layer 420 may differ from a length and diameter of the fibers in the layer 430 even though the fiber material present in the layers 420, 430 may be the same or different. In yet other examples, two or more different fibers may be used in one of the layers 420, 430 and a single type of fibers may be present in the other layer. As noted herein, by selecting the amount and/or type of fibers, it is possible to vary the physical properties of the surface layers 420, 430, e.g., to provide a different lofting capacity for different surface layers of the assembly.

In some examples, the core layer 410 may comprise a closed cell foam or other materials which are not a fiber reinforced thermoplastic layer e.g., the closed cell foam of the core layer 410 may comprise a porosity of less than about 5%, 4%, 3%, 2% or 1%. In some embodiments, the core layer is not a sprayed or sprayable core layer but is instead a solid, planar layer which can be coupled to the surface layers 420, 430 post-formation of the core layer 410. In some examples, the core layer 410 may comprise one or more of a foam, a cardboard, or a paper honeycomb or combinations thereof. In other examples, the core layer 410 may comprise or be a polystyrene foam, an expanded or extruded polyolefin foam (e.g., extruded polyethylene or expanded polypropylene) or other foams. In some instances, the core layer may lack any polyurethane materials and/or may lack any cellulose materials. By using certain foam materials in the core layer 410, a clean edge may exist, mold growth problems can be avoided and higher compressive strength may be obtained at lighter areal weights. Illustrative basis weights for the core layer 410 include, but are not limited to, about 300 gsm to about 2000 gsm, more particularly about 500 gsm to about 1900 gsm or about 500 gsm to about 1500 gsm

In some embodiments, the core layer 410 may comprise a foam with a larger compressive strength in a cross direction than in a machine direction. For example, the core layer 410 may comprise a foam with directional compressive strength, e.g., one with a compressive strength that is different in orthogonal directions, to impart more stiffness to the overall article comprising the core layer 410 and the surface layers 420, 430. Foams which can provide directional compressive strength are commercially available from Dow Corning and other suppliers. The core layer 410 is typically first formed from the foam (or other material) and then coupled to the surface layers 420, 430. In some configurations, the material of the core layer 410 can be constructed and arranged to permit compression of the core layer 410 without substantial damage to the core layer 410. Materials in the core layer 410 can also be selected to permit the article 400 (or the article 450) to be thermoformed, e.g., compressed, molded, etc., without substantial damage to the core layer 410. Compared to fiber thermoplastic core layers, at comparable basis weights the presence of a core layer 410 comprising a closed cell foam (or non-fiber reinforced thermoplastic materials) can provide better performance and higher strength.

In some configurations, the surface layers 420, 430 (and optionally the core layer 410 and adhesive layers 415, 425) may be a substantially halogen free or halogen free layer to meet the restrictions on hazardous substances requirements for certain applications. In other instances, one or more of the layers 410, 415, 420, 425, 430 may comprise a halogenated flame retardant agent such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo- polycarbonates. In some instances, the thermoplastic material used in one or more of the surface layers 420, 430 may comprise one or more halogens to impart some flame retardancy without the addition of another flame retardant agent. Where halogenated flame retardants are present, the flame retardant is desirably present in a flame retardant amount, which can vary depending on the other components which are present. For example, the halogenated flame retardant may be present in about 0.1 weight percent to about 15 weight percent (based on the weight of the layer), more particularly about 1 weight percent to about 13 weight percent, e.g., about 5 weight percent to about 13 weight percent. If desired, two different halogenated flame retardants may be added to the layers. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the layers may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the layer), more particularly about 1 weight percent to about 13 weight percent, e.g., about 5 weight percent to about 13 weight percent based on the weight of the layer. If desired, two different substantially halogen free flame retardants may be added to one or more of the layers 410, 415, 420, 425 and 430. In certain instances, one or more of the layers 410, 415, 420, 425 and 430 may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present may be about 0.1 weight percent to about 20 weight percent (based on the weight of the layer), more particularly about 1 weight percent to about 15 weight percent, e.g., about 2 weight percent to about 14 weight percent based on the weight of the layer. The flame retardant agents used in the layers described herein can be added to the mixture comprising the thermoplastic material and fibers (prior to disposal of the mixture on a wire screen or other processing component) or can be added after the layer is formed. In some examples, the flame retardant material may comprise one or more of expandable graphite materials, magnesium hydroxide (MDH) and aluminum hydroxide (ATH).

In the configuration shown in FIG. 4A (and/or FIG. 4B), the lofting capacity of the surface layers 420, 430 can be further tuned by including one or more added lofting agents. The exact type of lofting agent used in the layers 420, 430 can depend on numerous factors including, for example, the desired lofting temperature, the desired degree of loft, etc. In some instances, microsphere lofting agents, e.g., expandable microspheres, which can increase their size upon exposure to convection heating may be used. Illustrative commercially available lofting agents are available from Kureha Corp. (Japan). In other instances, a first lofting agent with a first average particle size and a second lofting agent with a second average particle size, different from the first average particle size, may be used. In other examples, the lofting agent may be an expandable graphite material. The surface layers 420, 430 can be configured to provide the same lofting capacity or different lofting capacities. For example, upon exposure to heat or other lofting stimulus, the post-loft thickness of the layer 420 can be greater than that of the layer 430. For example, the thickness of the layer 420 prior to lofting may be about 1-2 mm and after lofting may be about 10-15 mm. The thickness of the layer 430 prior to lofting may also be about 1-2 mm and after lofting may be about 6-8 mm. These thickness changes may occur even in the absence of any added lofting agent. For example and without wishing to be bound by any particular theory, during lofting the thermoplastic material may melt and release its hold on the reinforcing materials to permit the reinforcing materials to occupy more volume. Subsequent cooling of the thermoplastic material can result in reformation of a web of open celled structures with a larger volume than the pre-lofted web. By tuning the level of thermoplastic material and/or reinforcing materials in the layer 420 the degree to which the volume of the layer 420 can increase may be selected. In comparison, the amount of thermoplastic material and/or reinforcing materials present in the layer 430 can be selected such that melting of the thermoplastic material during lofting does not result in a substantial increase in the overall volume. As the web of the layer 430 reforms after lofting, the resulting post-lofted web volume is not substantially different from the pre-lofted web volume. If desired, one or more of the layers 420, 430 may include an added lofting agent to further increase the overall volume. For example, the layer 420 may comprise an added lofting agent to further select the overall post-lofted volume. In some instances, enough lofting agent is present so the post-lofted layer 420 (and/or the post-lofted layer 430) has a thickness of about 20-25 mm. In some examples, the layer 420 may comprise a polyolefin, reinforcing fibers and a lofting agent, and the layer 430 may comprise a polyolefin (which can be the same or different than the polyolefin in the layer 420) and a reinforcing material. In certain configurations, the polyolefin present in each of the layers 420, 430 may be polypropylene or a polyolefin copolymer comprising polypropylene. In some embodiments, the reinforcing material of each of the layers 420, 430 may comprise glass fibers optionally in combination with other fibers. The exact weight percentages of the thermoplastic material and reinforcing materials in each of the layers 420, 430 may vary, and illustrative weight percentages in the layers 420, 430 are about 40-60 weight percent thermoplastic material with the balance being reinforcing material. If desired, the surface layer 430 can be configured so it has a higher lofting capacity than the layer 420.

In certain configurations, one or both of the surface layers 420, 430 can be coupled to an additional layer or material. Referring to FIG. 4B, an article 450 is shown as comprising the surface layer 430 coupled to a layer 460. The layer 460 can take numerous forms and is typically different from the surface layers 420, 430, e.g., may not be a fiber reinforced thermoplastic layer. In some embodiments, the layer 460 may take the form of a skin. The skin 460 may comprise, for example, a film (e.g., thermoplastic film or elastomeric film), a frim, a scrim (e.g., fiber based scrim), a foil, a woven fabric, a non-woven fabric or be present as an inorganic coating, an organic coating, or a thermoset coating. In other instances, the skin 460 may comprise a limiting oxygen index greater than about 22, as measured per ISO 4589 dated 1996. Where a thermoplastic film is present as (or as part of) the skin 460, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present as (or as part of) the skin 460, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as (or as part of) the skin 460, the coating may comprise at least one of unsaturated polyurethanes, vinyl esters, phenolics and epoxies. Where an inorganic coating is present as (or as part of) the skin 460, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the skin 460, the non-woven fabric may comprise a thermoplastic material, a thermal setting binder, inorganic fibers, metal fibers, metallized inorganic fibers and metallized synthetic fibers. If desired, the skin 460 may also comprise a lofting agent as well.

In certain instances, the layer 460 may be configured as a decorative layer. The decorative layer 460 may be formed, e.g., from a thermoplastic film of polyvinyl chloride, polyolefins, thermoplastic polyesters, thermoplastic elastomers, or the like. The decorative layer 460 may comprise a carpet, rubber or other aesthetic covering. The decorative layer 460 may also be a multi-layered structure that includes a foam core formed from, e.g., polypropylene, polyethylene, polyvinyl chloride, polyurethane, and the like. A fabric may be bonded to the foam core, such as woven fabrics made from natural and synthetic fibers, organic fiber non-woven fabric after needle punching or the like, raised fabric, knitted goods, flocked fabric, or other such materials. The fabric may also be bonded to the foam core with a thermoplastic adhesive, including pressure sensitive adhesives and hot melt adhesives, such as polyamides, modified polyolefins, urethanes and polyolefins. The decorative layer 460 may also be produced using spunbond, thermal bonded, spun lace, melt-blown, wet-laid, and/or dry-laid processes. While not shown, a skin, e.g., scrim, film, decorative layer, etc. can also be coupled to the layer 420 if desired.

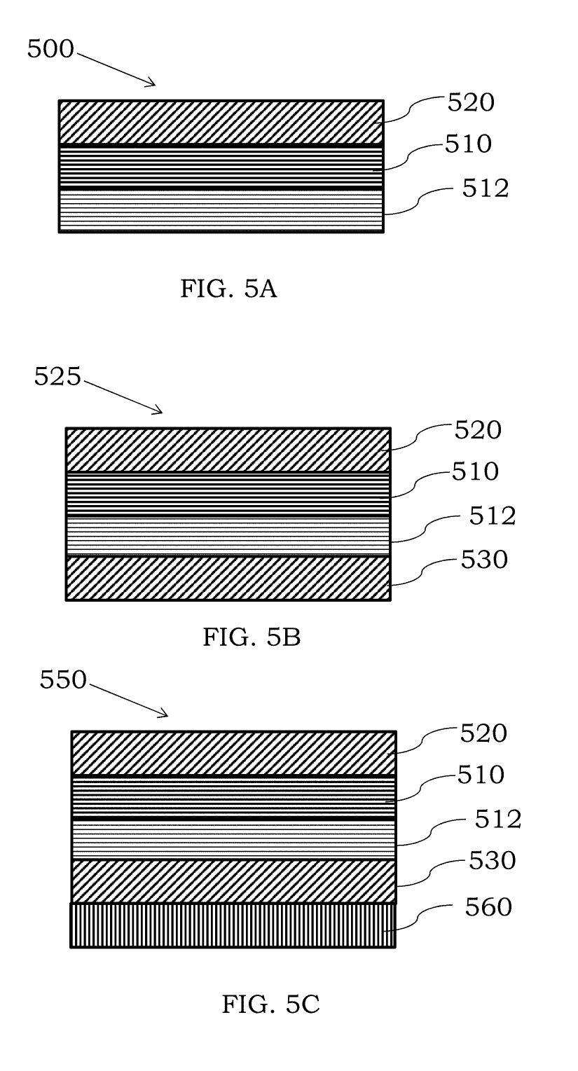

In certain configurations and referring to FIGS. 5A, 5B and 5C, a multi-layer assembly 500 (or 525 in FIG. 5B or 450 in FIG. 5C) may comprise a surface layer 520 and two or more core layers 510, 512 coupled to each other. As noted below, the core layers 510, 512 can be the same or can be different. In some examples, the core layers 510, 512 may independently comprise a closed cell foam or other materials which are not a fiber reinforced thermoplastic layer e.g., the closed cell foam of the core layer 510, 512 or both may comprise a porosity of less than about 5%, 4%, 3%, 2% or 1%. In some embodiments, one or both of the core layers 510 ,512 is not a sprayed or sprayable core layer but is instead a solid, planar layer which can be coupled to the surface layers 520 post-formation of the core layers 510, 512. In some examples, each of the core layers 510, 512 may independently comprise one or more of a foam, a cardboard, or a paper honeycomb or combinations thereof. In other examples, each of the core layers 510, 512 may independently comprise or be a polystyrene foam, an expanded or extruded polyolefin foam (e.g., extruded polyethylene or expanded polypropylene) or other foams. In some instances, one or both of the core layers 510, 512 may lack any polyurethane materials and/or may lack any cellulose materials. By using certain foam materials in one or both of the core layers 510, 512 a clean edge may exist, mold growth problems can be avoided and higher compressive strength may be obtained at lighter areal weights. Illustrative basis weights for each of the core layers 510, 512 include, but are not limited to, about 300 gsm to about 2000 gsm, more particularly about 500 gsm to about 1900 gsm or about 500 gsm to about 1500 gsm. The basis weights of the core layers 510, 512 can be the same or can be different.

In some embodiments, each of the core layers 510, 512 may independently comprise a foam with a larger compressive strength in a cross direction than in a machine direction. For example, one or both of the core layers 510, 512 may comprise a foam with directional compressive strength, e.g., one with a compressive strength that is different in orthogonal directions, to impart more stiffness to the overall article comprising the core layers 510, 512 and the surface layer 520. Foams which can provide directional compressive strength are commercially available from Dow Corning and other suppliers. Each of the core layers 510, 512 is typically first formed from the foam (or other material) and then coupled to each other and the surface layer 520. In some configurations, the material of one or both of the core layers 510, 512 can be constructed and arranged to permit compression of the core layers 510, 512 without substantial damage to the core layers 510, 512. Materials in the core layers 510, 512 can also be selected to permit the article 500 (or the articles 525, 550) to be thermoformed, e.g., compressed, molded, etc., without substantial damage to the core layers 510, 512. Compared to fiber thermoplastic core layers, at comparable basis weights the presence of a core layers 510, 512 comprising a closed cell foam (or non-fiber reinforced thermoplastic materials) can provide better performance and higher strength. The core layers 510, 512 can be directly coupled to each other without any intervening layers or materials or can be coupled to each other using, for example, an adhesive layer (not shown).

In certain embodiments, the surface layer 520 (and/or the surface layer 530 when present) may be configured as (or used in) a glass mat thermoplastic composite (GMT) or a light weight reinforced thermoplastic (LWRT). One such LWRT is prepared by HANWHA AZDEL, Inc. and sold under the trademark SUPERLITE® mat. The areal density of such a GMT or LWRT can range from about 400 grams per square meter (gsm) of the GMT or LWRT to about 4000 gsm, although the areal density may be less than 400 gsm or greater than 4000 gsm depending on the specific application needs. In some embodiments, the upper density can be less than about 4000 gsm. In certain instances, the GMT or the LWRT may comprise one or more lofting agent materials disposed in void space or pores of the GMT or the LWRT.

In certain examples where an LWRT is used as a surface layer 520 (and/or a surface layer 530 when present), the LWRT typically includes a thermoplastic material and a plurality of reinforcing fibers which together form a web of open celled structures. For example, the surface layer 520 (and/or layer 530) typically comprises a substantial amount of open cell structure such that void space is present in the layers. In some instances, the surface layer 520 may comprise a void content or porosity of 0-30%, 10-40%, 20-50%, 30-60%, 40-70%, 50-80%, 60-90%, 0-40%,0-50%,0-60%,0-70%,0-80%,0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% or any illustrative value within these exemplary ranges. In some instances, the surface layer 520 (and/or layer 530) comprises a porosity or void content of greater than 0%, e.g., is not fully consolidated, up to about 95%. Unless otherwise stated, the reference to the surface layer comprising a certain void content or porosity is based on the total volume of that surface layer and not necessarily the total volume of the multi-layer assembly.

In certain examples, the surface layer 520 (and/or layer 530) can be produced in the form of a GMT. In certain instances, the GMT can be generally prepared using chopped glass fibers, a thermoplastic material, optionally a lofting agent and an optional thermoplastic polymer film or films and/or woven or non-woven fabrics made with glass fibers or thermoplastic resin fibers such as, for example, polypropylene (PP), polybutylene terephthalate (PBT), polyethylene terephthalate (PET), polycarbonate (PC), a blend of PC/PBT, or a blend of PC/PET. In some embodiments, a PP, a PBT, a PET, a PC/PET blend or a PC/PBT blend can be used as a resin. To produce the glass mat, a thermoplastic material and reinforcing materials can be added or metered into a dispersing foam contained in an open top mixing tank fitted with an impeller. Without wishing to be bound by any particular theory, the presence of trapped pockets of air of the foam can assist in dispersing the glass fibers, the thermoplastic material and the lofting agent. In some examples, the dispersed mixture of fibers and thermoplastic material can be pumped to a head-box located above a wire section of a paper machine via a distribution manifold. The foam, not the fibers and thermoplastic, can then be removed as the dispersed mixture is provided to a moving wire screen using a vacuum, continuously producing a uniform, fibrous wet web. The wet web can be passed through a dryer at a suitable temperature to reduce moisture content and to melt or soften the thermoplastic material.

In certain embodiments, the high porosity present in the surface layer 520 (and/or layer 530) can reduce the overall weight of the layers and can permit the inclusion of agents within the void space. For example, lofting agents can reside in the void space in a non-covalently bonded manner. Application of heat or other perturbations can act to increase the volume of the non-covalently bonded lofting agent which in turn increases the overall thickness of the layer, e.g., the layer increases as the size of the lofting agent increases and/or additional air becomes trapped in the layer. If desired, flame retardants, colorants, smoke suppressants and other materials may be included in the void space of the surface layer 520 (and/or layer 530). Prior to lofting, the surface layer 520 (and/or layer 530) can be compressed to reduce its overall thickness, e.g., compressed before or after the layer is coupled to one or more other layers.

In certain embodiments, the thermoplastic material of the surface layer 520 (and/or layer 530) may comprise, at least in part, one or more of polyethylene, polypropylene, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as copolymers, alloys and blends of these materials with each other or other polymeric materials. The thermoplastic material used to form the layer 520 (and/or layer 530) can be used in powder form, resin form, rosin form, particle form, fiber form or other suitable forms. Illustrative thermoplastic materials in various forms are described herein and are also described, for example in U.S. Publication Nos. 20130244528 and US20120065283. The exact amount of thermoplastic material present in the surface layer 520 (and/or the layer 530) can vary and illustrative amounts range from about 20% by weight to about 80% by weight, e.g., 30-70 percent by weight or 35-65 percent by weight.

In certain examples, the reinforcing fibers of the surface layers 520 (and/or layer 530) may comprise glass fibers, carbon fibers, graphite fibers, synthetic organic fibers, particularly high modulus organic fibers such as, for example, para- and meta-aramid fibers, nylon fibers, polyester fibers, or any of the high melt flow index resins described herein that are suitable for use as fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In some embodiments, any of the aforementioned fibers can be chemically treated prior to use to provide desired functional groups or to impart other physical properties to the fibers, e.g., may be chemically treated so that they can react with the thermoplastic material, the lofting agent or both. The fiber content in the layer 520 (and/or layer 530) may independently be from about 20% to about 90% by weight of the layer, more particularly from about 30% to about 70%, by weight of the layer. Typically, the fiber content of a multi-layer assembly comprising the surface layer 520 (and/or layer 530) varies between about 20% to about 90% by weight, more particularly about 30% by weight to about 80% by weight, e.g., about 40% to about 70% by weight of the assembly. The particular size and/or orientation of the fibers used may depend, at least in part, on the thermoplastic polymer material used and/or the desired properties of the surface layer 520 (and/or layer 530). Suitable additional types of fibers, fiber sizes and amounts will be readily selected by the person of ordinary skill in the art, given the benefit of this disclosure. In one non-limiting illustration, fibers dispersed within a thermoplastic material and optionally a lofting agent to provide a surface layer 520 (and/or layer 530) can generally have a diameter of greater than about 5 microns, more particularly from about 5 microns to about 22 microns, and a length of from about 5 mm to about 200 mm, more particularly, the fiber diameter may be from about microns to about 22 microns and the fiber length may be from about 5 mm to about 75 mm.

In some embodiments, the lofting capacity of the surface layer 520 (and/or layer 530) can be further tuned by including one or more added lofting agents. The exact type of lofting agent used in the layer 520 (and/or layer 530) can depend on numerous factors including, for example, the desired lofting temperature, the desired degree of loft, etc. In some instances, microsphere lofting agents, e.g., expandable microspheres, which can increase their size upon exposure to convection heating may be used. Illustrative commercially available lofting agents are available from Kureha Corp. (Japan). In other instances, a first lofting agent with a first average particle size and a second lofting agent with a second average particle size, different from the first average particle size, may be used in the layer 520 (and/or layer 530). In other examples, the lofting agent may be an expandable graphite material.

In certain embodiments and referring to FIG. 5B, the surface layers 520, 530 can be the same or they can be different. In certain instances, the surface layers 520, 530 may generally comprise the same materials but may have different amounts of the materials, e.g., different amounts of reinforcing fibers and/or different amounts of thermoplastic materials. In other examples, the surface layers 520, 530 may comprise the same thermoplastic material but different reinforcing fibers. In additional configurations, the surface layers 520, 530 may comprise the same reinforcing fibers but different thermoplastic materials. In other instances, the surface layers 520, 530 may comprise the same reinforcing materials and thermoplastic materials but have a different basis weight, a different porosity or other different physical properties. In some examples, the surface layers 520, 530 may comprise the same reinforcing fibers and same thermoplastic materials but have a different thickness or a different amount of a lofting agent to provide for variable lofting capacities.

In certain configurations, the surface layer 520 is coupled to the core layer 510 through an adhesive layer (not shown), and the surface layer 540 can be coupled to the core layer 512 through an adhesive layer (not shown). The adhesive layers (when present) can act to couple the surface layers 520, 530 to the underlying core layers 510, 512, respectively to prevent separation of the surface layers 520, 530 from the core layer 510, 512. The adhesive layers need not have the same materials, thickness, etc. Illustrative adhesives that can independently be included in the adhesive layers include, but are not limited to, thermoplastic adhesives including, but not limited to, pressure sensitive adhesives and hot melt adhesives, such as polyamides, modified polyolefins, urethanes and polyolefins. In some examples, the thermoplastic component of the adhesive layers may independently comprise a thermoplastic polymer such as, for example, a polyolefin such as a polyethylene or a polypropylene. In other instances, the thermoplastic polymer of the adhesive layers may independently comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layers include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive layers may also independently comprise some thermosetting material including, but not limited to, epoxides, epoxy resins, polyesters, polyester resins, urethanes, polyurethanes, diallyl-phthalates, polymides, cyanate esters, polycyanurates and combinations thereof.

In certain embodiments, the surface layers 520, 530 may comprise a different fiber material or a different fiber loading. Where different fiber materials are present, the fibers may be different fibers entirely, e.g., glass fibers in one layer and carbon fibers in another layer, or may comprise the same base material that has been modified, e.g., glass fibers in one layer and chemically treated glass fibers in another layer. In some instances, the fibers may be the same fiber material but one or more physical properties of the fibers may differ. For example, the fibers of the layer 520 may have a first diameter that differs from a diameter of the fibers present in the layer 530 even though the fiber material in the layers 520, 530 may be the same or different. In other instances, the length of the fibers in the layer 520 may differ from a length of the fibers present in the layer 530 even though the fiber material present in the layers 520, 530 may be the same or different. In additional examples, both the length and diameter of the fiber in the layer 520 may differ from a length and diameter of the fibers in the layer 530 even though the fiber material present in the layers 520, 530 may be the same or different. In yet other examples, two or more different fibers may be used in one of the layers 520, 530 and a single type of fibers may be present in the other layer. As noted herein, by selecting the amount and/or type of fibers, it is possible to vary the physical properties of the surface layers 520, 530, e.g., to provide a different lofting capacity for different surface layers of the assembly.

In some configurations, the surface layers 520, 530 (and optionally the core layer 510, 512) may be a substantially halogen free or halogen free layer to meet the restrictions on hazardous substances requirements for certain applications. In other instances, one or more of the layers 510,512, 520, and 530 may comprise a halogenated flame retardant agent such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo- polycarbonates. In some instances, the thermoplastic material used in one or more of the surface layers 520, 530 may comprise one or more halogens to impart some flame retardancy without the addition of another flame retardant agent. Where halogenated flame retardants are present, the flame retardant is desirably present in a flame retardant amount, which can vary depending on the other components which are present. For example, the halogenated flame retardant may be present in about 0.1 weight percent to about 15 weight percent (based on the weight of the layer), more particularly about 1 weight percent to about 13 weight percent, e.g., about 5 weight percent to about 13 weight percent. If desired, two different halogenated flame retardants may be added to the layers. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the layers may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the layer), more particularly about 1 weight percent to about 13 weight percent, e.g., about 5 weight percent to about 13 weight percent based on the weight of the layer. If desired, two different substantially halogen free flame retardants may be added to one or more of the layers 510,512, 520, and 530. In certain instances, one or more of the layers 510,512, 520, and 530 may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present may be about 0.1 weight percent to about 20 weight percent (based on the weight of the layer), more particularly about 1 weight percent to about 15 weight percent, e.g., about 2 weight percent to about 14 weight percent based on the weight of the layer. The flame retardant agents used in the layers described herein can be added to the mixture comprising the thermoplastic material and fibers (prior to disposal of the mixture on a wire screen or other processing component) or can be added after the layer is formed. In some examples, the flame retardant material may comprise one or more of expandable graphite materials, magnesium hydroxide (MDH) and aluminum hydroxide (ATH).

In the configuration shown in FIG. 5A (and/or FIGS. 5B and 5C), the lofting capacity of the surface layers 520, 530 can be further tuned by including one or more added lofting agents. The exact type of lofting agent used in the layers 520, 530 can depend on numerous factors including, for example, the desired lofting temperature, the desired degree of loft, etc. In some instances, microsphere lofting agents, e.g., expandable microspheres, which can increase their size upon exposure to convection heating may be used. Illustrative commercially available lofting agents are available from Kureha Corp. (Japan). In other instances, a first lofting agent with a first average particle size and a second lofting agent with a second average particle size, different from the first average particle size, may be used. In other examples, the lofting agent may be an expandable graphite material. The surface layers 520, 530 can be configured to provide the same lofting capacity or different lofting capacities. For example, upon exposure to heat or other lofting stimulus, the post-loft thickness of the layer 520 can be greater than that of the layer 530. For example, the thickness of the layer 520 prior to lofting may be about 1-2 mm and after lofting may be about 10-15 mm. The thickness of the layer 530 prior to lofting may also be about 1-2 mm and after lofting may be about 6-8 mm. These thickness changes may occur even in the absence of any added lofting agent. For example and without wishing to be bound by any particular theory, during lofting the thermoplastic material may melt and release its hold on the reinforcing materials to permit the reinforcing materials to occupy more volume. Subsequent cooling of the thermoplastic material can result in reformation of a web of open celled structures with a larger volume than the pre-lofted web. By tuning the level of thermoplastic material and/or reinforcing materials in the layer 520 the degree to which the volume of the layer 520 can increase may be selected. In comparison, the amount of thermoplastic material and/or reinforcing materials present in the layer 530 can be selected such that melting of the thermoplastic material during lofting does not result in a substantial increase in the overall volume. As the web of the layer 530 reforms after lofting, the resulting post-lofted web volume is not substantially different from the pre-lofted web volume. If desired, one or more of the layers 520, 530 may include an added lofting agent to further increase the overall volume. For example, the layer 520 may comprise an added lofting agent to further select the overall post-lofted volume. In some instances, enough lofting agent is present so the post-lofted layer 520 (and/or the post-lofted layer 530) has a thickness of about 20-25 mm. In some examples, the layer 520 may comprise a polyolefin, reinforcing fibers and a lofting agent, and the layer 530 may comprise a polyolefin (which can be the same or different than the polyolefin in the layer 520) and a reinforcing material. In certain configurations, the polyolefin present in each of the layers 520, 530 may be polypropylene or a polyolefin copolymer comprising polypropylene. In some embodiments, the reinforcing material of each of the layers 520, 530 may comprise glass fibers optionally in combination with other fibers. The exact weight percentages of the thermoplastic material and reinforcing materials in each of the layers 520, 530 may vary, and illustrative weight percentages in the layers 520, 530 are about 40-60 weight percent thermoplastic material with the balance being reinforcing material. If desired, the surface layer 530 can be configured so it has a higher lofting capacity than the layer 520.

In certain configurations, one or both of the surface layers 520, 530 can be coupled to an additional layer or material. Referring to FIG. 5C, an article 550 is shown as comprising the surface layer 530 coupled to a layer 560. The layer 560 can take numerous forms and is typically different from the surface layers 520, 530, e.g., may not be a fiber reinforced thermoplastic layer. In some embodiments, the layer 560 may take the form of a skin. The skin 560 may comprise, for example, a film (e.g., thermoplastic film or elastomeric film), a frim, a scrim (e.g., fiber based scrim), a foil, a woven fabric, a non-woven fabric or be present as an inorganic coating, an organic coating, or a thermoset coating. In other instances, the skin 560 may comprise a limiting oxygen index greater than about 22, as measured per ISO 4589 dated 1996. Where a thermoplastic film is present as (or as part of) the skin 560, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present as (or as part of) the skin 560, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as (or as part of) the skin 560, the coating may comprise at least one of unsaturated polyurethanes, vinyl esters, phenolics and epoxies. Where an inorganic coating is present as (or as part of) the skin 560, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the skin 560, the non-woven fabric may comprise a thermoplastic material, a thermal setting binder, inorganic fibers, metal fibers, metallized inorganic fibers and metallized synthetic fibers. If desired, the skin 560 may also comprise a lofting agent as well.

In certain instances, the layer 560 may be configured as a decorative layer. The decorative layer 560 may be formed, e.g., from a thermoplastic film of polyvinyl chloride, polyolefins, thermoplastic polyesters, thermoplastic elastomers, or the like. The decorative layer 560 may comprise a carpet, rubber or other aesthetic covering. The decorative layer 560 may also be a multi-layered structure that includes a foam core formed from, e.g., polypropylene, polyethylene, polyvinyl chloride, polyurethane, and the like. A fabric may be bonded to the foam core, such as woven fabrics made from natural and synthetic fibers, organic fiber non-woven fabric after needle punching or the like, raised fabric, knitted goods, flocked fabric, or other such materials. The fabric may also be bonded to the foam core with a thermoplastic adhesive, including pressure sensitive adhesives and hot melt adhesives, such as polyamides, modified polyolefins, urethanes and polyolefins. The decorative layer 560 may also be produced using spunbond, thermal bonded, spun lace, melt-blown, wet-laid, and/or dry-laid processes. While not shown, a skin, e.g., scrim, film, decorative layer, etc. can also be coupled to the layer 520 if desired.

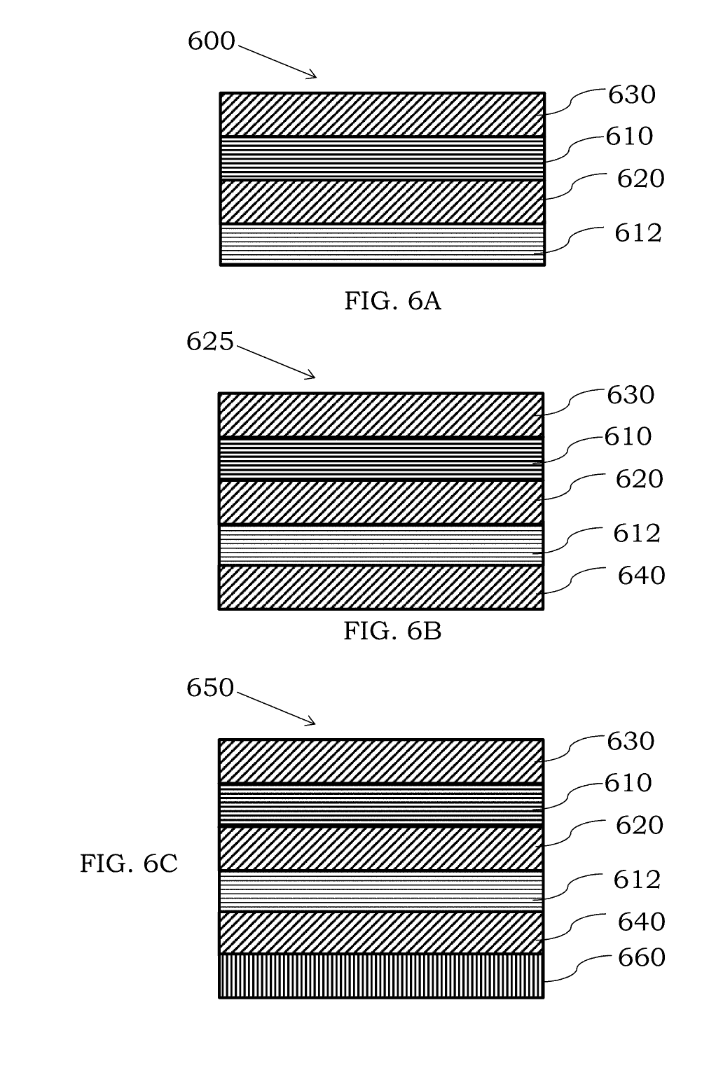

In certain examples and referring to FIGS. 6A, 6B and 6C, a multi-layer assembly 600 (or 625 in FIG. 6B or 650 in FIG. 6C) may comprise two or more core layers 610, 612 coupled to each other through a fiber reinforced thermoplastic layer 620. An optional surface layer 630 may also be present in the articles 600, 625 and 650. In certain examples, the core layers 610, 612 can be the same or can be different. In some examples, the core layers 610, 612 may independently comprise a closed cell foam or other materials which are not a fiber reinforced thermoplastic layer e.g., the closed cell foam of the core layers 610, 612 or both may comprise a porosity of less than about 5%, 4%, 3%, 2% or 1%. In some embodiments, one or both of the core layers 610, 612 is not a sprayed or sprayable core layer but is instead a solid, planar layer which can be coupled to the layer 620 and the surface layer 630 post-formation of the core layers 610, 612. In some examples, each of the core layers 610, 612 may independently comprise one or more of a foam, a cardboard, or a paper honeycomb or combinations thereof. In other examples, each of the core layers 610, 612 may independently comprise or be a polystyrene foam, an expanded or extruded polyolefin foam (e.g., extruded polyethylene or expanded polypropylene) or other foams. In some instances, one or both of the core layers 610, 612 may lack any polyurethane materials and/or may lack any cellulose materials. By using certain foam materials in one or both of the core layers 610, 612 a clean edge may exist, mold growth problems can be avoided and higher compressive strength may be obtained at lighter areal weights. Illustrative basis weights for each of the core layers 610, 612 include, but are not limited to, about 300 gsm to about 2000 gsm, more particularly about 500 gsm to about 1900 gsm or about 500 gsm to about 1500 gsm. The basis weights of the core layers 610, 612 can be the same or can be different.

In some embodiments, each of the core layers 610, 612 may independently comprise a foam with a larger compressive strength in a cross direction than in a machine direction. For example, one or both of the core layers 610, 612 may comprise a foam with directional compressive strength, e.g., one with a compressive strength that is different in orthogonal directions, to impart more stiffness to the overall article comprising the core layers 610, 612 and the layer 620 and optional surface layer 630. Foams which can provide directional compressive strength are commercially available from Dow Corning and other suppliers. Each of the core layers 610, 612 is typically first formed from the foam (or other material) and then coupled to each other through the layer 620 and optionally through one or more adhesive layers (not shown). In some configurations, the material of one or both of the core layers 610, 612 can be constructed and arranged to permit compression of the core layers 610, 612 without substantial damage to the core layers 610, 612. Materials in the core layers 610, 612 can also be selected to permit the article 600 (or the articles 625, 650) to be thermoformed, e.g., compressed, molded, etc., without substantial damage to the core layers 610, 612. Compared to fiber thermoplastic core layers, at comparable basis weights the presence of a core layers 610, 612 comprising a closed cell foam (or non-fiber reinforced thermoplastic materials) can provide better performance and higher strength. The core layer 610 can be coupled to the optional surface layer 630 directly without any intervening layers or materials or can be coupled to the layer 630 using, for example, an adhesive layer (not shown).

In certain embodiments, the layer 620 (and/or the surface layer 630 when present) may be configured as (or used in) a glass mat thermoplastic composite (GMT) or a light weight reinforced thermoplastic (LWRT). One such LWRT is prepared by HANWHA AZDEL, Inc. and sold under the trademark SUPERLITE® mat. The areal density of such a GMT or LWRT can range from about 400 grams per square meter (gsm) of the GMT or LWRT to about 4000 gsm, although the areal density may be less than 400 gsm or greater than 4000 gsm depending on the specific application needs. In some embodiments, the upper density can be less than about 4000 gsm. In certain instances, the GMT or the LWRT may comprise one or more lofting agent materials disposed in void space or pores of the GMT or the LWRT.

In certain examples where an LWRT is used as a surface layer 620 (and/or a surface layer 630 when present), the LWRT typically includes a thermoplastic material and a plurality of reinforcing fibers which together form a web of open celled structures. For example, the surface layer 620 (and/or layer 630) typically comprises a substantial amount of open cell structure such that void space is present in the layers. In some instances, the surface layer 620 may comprise a void content or porosity of 0-30%, 10-40%, 20-50%, 30-60%, 40-70%, 50-80%, 60-90%, 0-40%,0-50%,0-60%,0-70%,0-80%,0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% or any illustrative value within these exemplary ranges. In some instances, the surface layer 620 (and/or layer 630) comprises a porosity or void content of greater than 0%, e.g., is not fully consolidated, up to about 95%. Unless otherwise stated, the reference to the surface layer comprising a certain void content or porosity is based on the total volume of that surface layer and not necessarily the total volume of the multi-layer assembly.

In certain examples, the layer 620 (and/or layer 630) can be produced in the form of a GMT. In certain instances, the GMT can be generally prepared using chopped glass fibers, a thermoplastic material, optionally a lofting agent and an optional thermoplastic polymer film or films and/or woven or non-woven fabrics made with glass fibers or thermoplastic resin fibers such as, for example, polypropylene (PP), polybutylene terephthalate (PBT), polyethylene terephthalate (PET), polycarbonate (PC), a blend of PC/PBT, or a blend of PC/PET. In some embodiments, a PP, a PBT, a PET, a PC/PET blend or a PC/PBT blend can be used as a resin. To produce the glass mat, a thermoplastic material and reinforcing materials can be added or metered into a dispersing foam contained in an open top mixing tank fitted with an impeller. Without wishing to be bound by any particular theory, the presence of trapped pockets of air of the foam can assist in dispersing the glass fibers, the thermoplastic material and the lofting agent. In some examples, the dispersed mixture of fibers and thermoplastic material can be pumped to a head-box located above a wire section of a paper machine via a distribution manifold. The foam, not the fibers and thermoplastic, can then be removed as the dispersed mixture is provided to a moving wire screen using a vacuum, continuously producing a uniform, fibrous wet web. The wet web can be passed through a dryer at a suitable temperature to reduce moisture content and to melt or soften the thermoplastic material.

In certain embodiments, the high porosity present in the layer 620 (and/or layer 630) can reduce the overall weight of the layers and can permit the inclusion of agents within the void space. For example, lofting agents can reside in the void space in a non-covalently bonded manner. Application of heat or other perturbations can act to increase the volume of the non-covalently bonded lofting agent which in turn increases the overall thickness of the layer, e.g., the layer increases as the size of the lofting agent increases and/or additional air becomes trapped in the layer. If desired, flame retardants, colorants, smoke suppressants and other materials may be included in the void space of the layer 620 (and/or layer 630). Prior to lofting, the layer 620 (and/or layer 630) can be compressed to reduce its overall thickness, e.g., compressed before or after the layer is coupled to one or more other layers.

In certain embodiments, the thermoplastic material of the layer 620 (and/or layer 630) may comprise, at least in part, one or more of polyethylene, polypropylene, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as copolymers, alloys and blends of these materials with each other or other polymeric materials. The thermoplastic material used to form the layer 620 (and/or layer 630) can be used in powder form, resin form, rosin form, particle form, fiber form or other suitable forms. Illustrative thermoplastic materials in various forms are described herein and are also described, for example in U.S. Publication Nos. 20130244528 and US20120065283. The exact amount of thermoplastic material present in the layer 620 (and/or layer 630) can vary and illustrative amounts range from about 20% by weight to about 80% by weight, e.g., 30-70 percent by weight or 35-65 percent by weight.

In certain examples, the reinforcing fibers of the layer 620 (and/or layer 630) may comprise glass fibers, carbon fibers, graphite fibers, synthetic organic fibers, particularly high modulus organic fibers such as, for example, para- and meta-aramid fibers, nylon fibers, polyester fibers, or any of the high melt flow index resins described herein that are suitable for use as fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In some embodiments, any of the aforementioned fibers can be chemically treated prior to use to provide desired functional groups or to impart other physical properties to the fibers, e.g., may be chemically treated so that they can react with the thermoplastic material, the lofting agent or both. The fiber content in the layer 620 (and/or layer 630) may independently be from about 20% to about 90% by weight of the layer, more particularly from about 30% to about 70%, by weight of the layer. Typically, the fiber content of a multi-layer assembly comprising the layer 620 (and/or layer 630) varies between about 20% to about 90% by weight, more particularly about 30% by weight to about 80% by weight, e.g., about 40% to about 70% by weight of the assembly. The particular size and/or orientation of the fibers used may depend, at least in part, on the thermoplastic polymer material used and/or the desired properties of the layer 620 (and/or layer 630). Suitable additional types of fibers, fiber sizes and amounts will be readily selected by the person of ordinary skill in the art, given the benefit of this disclosure. In one non-limiting illustration, fibers dispersed within a thermoplastic material and optionally a lofting agent to provide a layer 620 (and/or layer 630) can generally have a diameter of greater than about 5 microns, more particularly from about 5 microns to about 22 microns, and a length of from about 5 mm to about 200 mm, more particularly, the fiber diameter may be from about microns to about 22 microns and the fiber length may be from about 5 mm to about 75 mm.

In some embodiments, the lofting capacity of the layer 620 (and/or layer 630) can be further tuned by including one or more added lofting agents. The exact type of lofting agent used in the layer 620 (and/or layer 630) can depend on numerous factors including, for example, the desired lofting temperature, the desired degree of loft, etc. In some instances, microsphere lofting agents, e.g., expandable microspheres, which can increase their size upon exposure to convection heating may be used. Illustrative commercially available lofting agents are available from Kureha Corp. (Japan). In other instances, a first lofting agent with a first average particle size and a second lofting agent with a second average particle size, different from the first average particle size, may be used in the layer 620 (and/or layer 630). In other examples, the lofting agent may be an expandable graphite material.

In certain embodiments, the layers 620, 630 can be the same or they can be different. In certain instances, the surface layers 620, 630 may generally comprise the same materials but may have different amounts of the materials, e.g., different amounts of reinforcing fibers and/or different amounts of thermoplastic materials. In other examples, the layers 620, 630 may comprise the same thermoplastic material but different reinforcing fibers. In additional configurations, the layers 620, 630 may comprise the same reinforcing fibers but different thermoplastic materials. In other instances, the layers 620, 630 may comprise the same reinforcing materials and thermoplastic materials but have a different basis weight, a different porosity or other different physical properties. In some examples, the layers 620, 630 may comprise the same reinforcing fibers and same thermoplastic materials but have a different thickness or a different amount of a lofting agent to provide for variable lofting capacities.

In certain configurations, the layer 620 is coupled to the core layers 610, 612 through adhesive layers (not shown), and the surface layer 630 can be coupled to the core layer 610 through an adhesive layer (not shown). If desired and as shown in FIG. 6B, another surface layer 640 can be coupled to the core layer 612 through an adhesive layer. The adhesive layers (when present) can act to couple the various layer to the underlying core layers 610, 612 to prevent separation of the layers 620, 630, 640 from the core layers 610, 612. The adhesive layers need not have the same materials, thickness, etc. Illustrative adhesives that can independently be included in the adhesive layers include, but are not limited to, thermoplastic adhesives including, but not limited to, pressure sensitive adhesives and hot melt adhesives, such as polyamides, modified polyolefins, urethanes and polyolefins. In some examples, the thermoplastic component of the adhesive layers may independently comprise a thermoplastic polymer such as, for example, a polyolefin such as a polyethylene or a polypropylene. In other instances, the thermoplastic polymer of the adhesive layers may independently comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layers include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive layers may also independently comprise some thermosetting material including, but not limited to, epoxides, epoxy resins, polyesters, polyester resins, urethanes, polyurethanes, diallyl-phthalates, polymides, cyanate esters, polycyanurates and combinations thereof.

In certain embodiments, the surface layers 620, 640 may comprise a different fiber material or a different fiber loading. Where different fiber materials are present, the fibers may be different fibers entirely, e.g., glass fibers in one layer and carbon fibers in another layer, or may comprise the same base material that has been modified, e.g., glass fibers in one layer and chemically treated glass fibers in another layer. In some instances, the fibers may be the same fiber material but one or more physical properties of the fibers may differ. For example, the fibers of the layer 630 may have a first diameter that differs from a diameter of the fibers present in the layer 640 even though the fiber material in the layers 630, 640 may be the same or different. In other instances, the length of the fibers in the layer 630 may differ from a length of the fibers present in the layer 640 even though the fiber material present in the layers 630, 640 may be the same or different. In additional examples, both the length and diameter of the fiber in the layer 630 may differ from a length and diameter of the fibers in the layer 640 even though the fiber material present in the layers 630, 640 may be the same or different. In yet other examples, two or more different fibers may be used in one of the layers 630, 640 and a single type of fibers may be present in the other layer. As noted herein, by selecting the amount and/or type of fibers, it is possible to vary the physical properties of the surface layers 630, 640, e.g., to provide a different lofting capacity for different surface layers of the assembly.

In some configurations, the surface layers 630, 640 (and optionally the core layers 610, 612 and the layer 620) may be a substantially halogen free or halogen free layer to meet the restrictions on hazardous substances requirements for certain applications. In other instances, one or more of the layers 610,612, 620, 630 and 640 may comprise a halogenated flame retardant agent such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo-polycarbonates. In some instances, the thermoplastic material used in one or more of the surface layers 630, 640 may comprise one or more halogens to impart some flame retardancy without the addition of another flame retardant agent. Where halogenated flame retardants are present, the flame retardant is desirably present in a flame retardant amount, which can vary depending on the other components which are present. For example, the halogenated flame retardant may be present in about 0.1 weight percent to about 15 weight percent (based on the weight of the layer), more particularly about 1 weight percent to about 13 weight percent, e.g., about 5 weight percent to about 13 weight percent. If desired, two different halogenated flame retardants may be added to the layers. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the layers may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the layer), more particularly about 1 weight percent to about 13 weight percent, e.g., about 5 weight percent to about 13 weight percent based on the weight of the layer. If desired, two different substantially halogen free flame retardants may be added to one or more of the layers 610,612, 620, 630 and 640. In certain instances, one or more of the layers 610,612, 620, 630 and 640 may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present may be about 0.1 weight percent to about 20 weight percent (based on the weight of the layer), more particularly about 1 weight percent to about 15 weight percent, e.g., about 2 weight percent to about 14 weight percent based on the weight of the layer. The flame retardant agents used in the layers described herein can be added to the mixture comprising the thermoplastic material and fibers (prior to disposal of the mixture on a wire screen or other processing component) or can be added after the layer is formed. In some examples, the flame retardant material may comprise one or more of expandable graphite materials, magnesium hydroxide (MDH) and aluminum hydroxide (ATH).

In the configuration shown in FIG. 6A (and/or FIGS. 6B and 6C), the lofting capacity of the layers 620, 630 and 640 can be further tuned by including one or more added lofting agents. The exact type of lofting agent used in the layers 620, 630, 640 can depend on numerous factors including, for example, the desired lofting temperature, the desired degree of loft, etc. In some instances, microsphere lofting agents, e.g., expandable microspheres, which can increase their size upon exposure to convection heating may be used in any one or more of the layers 620, 630 and 640. Illustrative commercially available lofting agents are available from Kureha Corp. (Japan). In other instances, a first lofting agent with a first average particle size and a second lofting agent with a second average particle size, different from the first average particle size, may be used. In other examples, the lofting agent may be an expandable graphite material. The layers 620, 630 and 640 can be configured to provide the same lofting capacity or different lofting capacities. For example, upon exposure to heat or other lofting stimulus, the post-loft thickness of the layer 620 can be greater than that of the layer 630. For example, the thickness of the layer 620 prior to lofting may be about 1-2 mm and after lofting may be about 10-15 mm. The thickness of the layer 630 prior to lofting may also be about 1-2 mm and after lofting may be about 6-8 mm. These thickness changes may occur even in the absence of any added lofting agent. For example and without wishing to be bound by any particular theory, during lofting the thermoplastic material may melt and release its hold on the reinforcing materials to permit the reinforcing materials to occupy more volume. Subsequent cooling of the thermoplastic material can result in reformation of a web of open celled structures with a larger volume than the pre-lofted web. By tuning the level of thermoplastic material and/or reinforcing materials in the layer 620 the degree to which the volume of the layer 620 can increase may be selected. In comparison, the amount of thermoplastic material and/or reinforcing materials present in the layer 630 can be selected such that melting of the thermoplastic material during lofting does not result in a substantial increase in the overall volume. As the web of the layer 630 reforms after lofting, the resulting post-lofted web volume is not substantially different from the pre-lofted web volume. If desired, one or more of the layers 620, 630 and 640 may include an added lofting agent to further increase the overall volume. For example, the layer 620 may comprise an added lofting agent to further select the overall post-lofted volume. In some instances, enough lofting agent is present so the post-lofted layer 620 (and/or the post-lofted layers 630, 640) has a thickness of about 20-25 mm. In some examples, the layer 620 may comprise a polyolefin, reinforcing fibers and a lofting agent, and the layers 630, 640 may each comprise a polyolefin (which can be the same or different than the polyolefin in the layer 620) and a reinforcing material. In certain configurations, the polyolefin present in each of the layers 620, 630 and 640 may be polypropylene or a polyolefin copolymer comprising polypropylene. In some embodiments, the reinforcing material of each of the layers 620, 630 and 640 may comprise glass fibers optionally in combination with other fibers. The exact weight percentages of the thermoplastic material and reinforcing materials in each of the layers 620, 630 and 640 may vary, and illustrative weight percentages in the layers 620, 630 and 640 are about 40-60 weight percent thermoplastic material with the balance being reinforcing material. If desired, the surface layers 630 and 640 can be configured so they have a higher lofting capacity than the layer 620.

In certain configurations, one or both of the surface layers 630, 640 can be coupled to an additional layer or material. Referring to FIG. 6C, an article 650 is shown as comprising the surface layer 640 coupled to a layer 660. The layer 660 can take numerous forms and is typically different from the surface layers 630, 640, e.g., may not be a fiber reinforced thermoplastic layer. In some embodiments, the layer 660 may take the form of a skin. The skin 660 may comprise, for example, a film (e.g., thermoplastic film or elastomeric film), a frim, a scrim (e.g., fiber based scrim), a foil, a woven fabric, a non-woven fabric or be present as an inorganic coating, an organic coating, or a thermoset coating. In other instances, the skin 660 may comprise a limiting oxygen index greater than about 22, as measured per ISO 4589 dated 1996. Where a thermoplastic film is present as (or as part of) the skin 660, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present as (or as part of) the skin 660, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as (or as part of) the skin 660, the coating may comprise at least one of unsaturated polyurethanes, vinyl esters, phenolics and epoxies. Where an inorganic coating is present as (or as part of) the skin 660, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the skin 660, the non-woven fabric may comprise a thermoplastic material, a thermal setting binder, inorganic fibers, metal fibers, metallized inorganic fibers and metallized synthetic fibers. If desired, the skin 660 may also comprise a lofting agent as well.

In certain instances, the layer 660 may be configured as a decorative layer. The decorative layer 660 may be formed, e.g., from a thermoplastic film of polyvinyl chloride, polyolefins, thermoplastic polyesters, thermoplastic elastomers, or the like. The decorative layer 560 may comprise a carpet, rubber or other aesthetic covering. The decorative layer 660 may also be a multi-layered structure that includes a foam core formed from, e.g., polypropylene, polyethylene, polyvinyl chloride, polyurethane, and the like. A fabric may be bonded to the foam core, such as woven fabrics made from natural and synthetic fibers, organic fiber non-woven fabric after needle punching or the like, raised fabric, knitted goods, flocked fabric, or other such materials. The fabric may also be bonded to the foam core with a thermoplastic adhesive, including pressure sensitive adhesives and hot melt adhesives, such as polyamides, modified polyolefins, urethanes and polyolefins. The decorative layer 660 may also be produced using spunbond, thermal bonded, spun lace, melt-blown, wet-laid, and/or dry-laid processes. While not shown, a skin, e.g., scrim, film, decorative layer, etc. can also be coupled to the layer 630 if desired.

In some embodiments, the fiber reinforced thermoplastic layers described herein may include additional materials or additives to impart desired physical or chemical properties. For example, one or more dyes, texturizing agents, colorants, viscosity modifiers, smoke suppressants, synergistic materials, lofting agents, particles, powders, biocidal agents, foams or other materials can be mixed with or added to the layers. In some instances, the layers may comprise one or more smoke suppressant compositions in the amount of about 0.2 weight percent to about 10 weight percent. Illustrative smoke suppressant compositions include, but are not limited to, stannates, zinc borates, zinc molybdate, magnesium silicates, calcium zinc molybdate, calcium silicates, calcium hydroxides, and mixtures thereof. If desired, a synergist material can be present to enhance the physical properties of the layers. If desired, a synergist material that enhances lofting ability may be present. Illustrative synergist materials include, but are not limited to, sodium trichlorobenzene sulfonate potassium, diphenyl sulfone-3-sulfonate, and mixtures thereof.

In certain examples, each of the layers of the multi-layer assembly can be separately produced and then combined together to form the multi-layer assembly. For example, each of the layers may be separately produced in a wet laid or other process and then combined together to provide the multi-layer assembly. In producing the various fiber reinforced thermoplastic layers described herein, it may be desirable to use a wet-laid process. For example, a liquid or fluid medium comprising dispersed material, e.g., thermoplastic materials, fibers and optionally lofting agent material optionally with any one or more additives described herein (e.g., other lofting agents or flame retardant agents), may be stirred or agitated in the presence of a gas, e.g., air or other gas. The dispersion may then be laid onto a support, e.g., a wire screen or other support material. The stirred dispersion may comprise one or more active agents, e.g., anionic, cationic, or non-ionic such as, for example, those sold under the name ACE liquid by Industrial Soaps Ltd., that sold as TEXOFOR® FN 15 material, by Glover Chemicals Ltd., and those sold as AMINE Fb 19 material by Float-Ore Ltd. These agents can assist in dispersal of air in the liquid dispersion. The components can be added to a mixing tank, flotation cell or other suitable devices in the presence of air to provide the dispersion. While an aqueous dispersion is desirably used, one or more non-aqueous fluids may also be present to assist in dispersion, alter the viscosity of the fluid or otherwise impart a desired physical or chemical property to the dispersion or the layer.

In certain instances, after the dispersion has been mixed for a sufficient period, the fluid with the suspended materials can be disposed onto a screen, moving wire or other suitable support structure to provide a web of laid down material. Suction or reduced pressure may be provided to the web to remove any liquid from laid down material to leave behind the thermoplastic material, lofting agent and any other materials that are present, e.g., fibers, additives, etc. The resulting web can be dried, consolidated, pressed, lofted, laminated, sized or otherwise processed further to provide a desired layer or article. In some instances, an additive or additional lofting agent material can be added to the web prior to drying, consolidation, pressing, lofting, laminating, sizing or other further processing to provide a desired layer or article. In other instances, the lofting agent may be added to the web subsequent to drying, consolidation, pressing, lofting, laminating, sizing or other further processing to provide a desired layer or article. While wet laid processes may be used, depending on the nature of the thermoplastic material, the lofting agent material and other materials present, it may be desirable to instead use an air laid process, a dry blend process, a carding and needle process, or other known process that are employed for making non-woven products.

In some configurations, the fiber reinforced thermoplastic layers described herein can be produced by combining a thermoplastic material, fibers, and an optional microsphere lofting agent in the presence of a surfactant in an aqueous solution or foam. The combined components can be mixed or agitated for a sufficient time to disperse the various materials and provide a substantially homogeneous aqueous mixture of the materials. The dispersed mixture is then laid down on any suitable support structure, for example, a wire mesh or other mesh or support having a desired porosity. Water can then be evacuated through the wire mesh forming a web. The web is dried and heated above the softening temperature of the thermoplastic powder. The web is then cooled and pressed to a predetermined thickness to produce a composite sheet having a void content of between about 1 percent to about 95 percent. In an alternate embodiment, the aqueous foam also includes a binder material. In some configurations, after the web is heated above the softening temperature of the thermoplastic powder, an adhesive layer comprising a thermoplastic polymer and a thermosetting material can then be disposed on the web.

In certain examples, one or more of the fiber reinforced thermoplastic layers can be produced in the form of a GMT. In certain instances, the GMT can be generally prepared using chopped glass fibers, a thermoplastic material, lofting agent and an optional thermoplastic polymer film or films and/or woven or non-woven fabrics made with glass fibers or thermoplastic resin fibers such as, for example, polypropylene (PP), polybutylene terephthalate (PBT), polyethylene terephthalate (PET), polycarbonate (PC), a blend of PC/PBT, or a blend of PC/PET. In some embodiments, a PP, a PBT, a PET, a PC/PET blend or a PC/PBT blend can be used as a resin. To produce the glass mat, a thermoplastic material, reinforcing materials, lofting agent and/or other additives can be added or metered into a dispersing foam contained in an open top mixing tank fitted with an impeller. Without wishing to be bound by any particular theory, the presence of trapped pockets of air of the foam can assist in dispersing the glass fibers, the thermoplastic material and the lofting agent. In some examples, the dispersed mixture of glass and resin can be pumped to a head-box located above a wire section of a paper machine via a distribution manifold. The foam, not the glass fiber, lofting agent or thermoplastic, can then be removed as the dispersed mixture is provided to a moving wire screen using a vacuum, continuously producing a uniform, fibrous wet web. The wet web can be passed through a dryer at a suitable temperature to reduce moisture content and to melt or soften the thermoplastic material. When the hot web exits the dryer, a surface layer such as, for example, an adhesive layer comprising a thermoplastic polymer and a thermosetting material may be laid onto the web by passing the web of glass fiber, lofting agent, thermoplastic material and film through the nip of a set of heated rollers followed by spraying of the adhesive onto the surface of the web. If desired, additional layers such as, for example, a non-woven and/or woven fabric layer or skin layer may also be attached to one side or to both sides of the web to facilitate ease of handling the glass fiber-reinforced mat. The composite can then be passed through tension rolls and continuously cut (guillotined) into the desired size for later forming into an end product article. Further information concerning the preparation of such GMT composites, including suitable materials and processing conditions used in forming such composites, are described, for example, in U.S. Pat. Nos. 6,923,494, 4,978,489, 4,944,843, 4,964,935, 4,734,321, 5,053,449, 4,925,615, 5,609,966 and U.S. Patent Application Publication Nos. US 2005/0082881, US2005/0228108, US 2005/0217932, US 2005/0215698, US 2005/0164023, and US 2005/0161865.

In some instances, each of the fiber reinforced thermoplastic layers may be formed separately as a sheet which is then used to provide a multi-layer article. For example, a wet laid process can be used to produce a first fiber reinforced thermoplastic sheet with a low lofting capacity. A wet laid process can also be used to produce a second fiber reinforced thermoplastic sheet with a higher lofting capacity than the first sheet. Each sheet may be processed prior to coupling to each other. For example, each sheet may be compressed to provide for a desired thickness. Any one, two or more of the produced fiber reinforced thermoplastic sheets can be coupled to a core layer a multi-layer assembly as described herein. While the coupling process may vary, in some instances, one first fiber reinforced thermoplastic sheet is heated to a temperature where the thermoplastic component softens. The heated fiber reinforced thermoplastic sheet can then be coupled to a core layer. If desired, a second fiber reinforced thermoplastic sheet, which may be the same or different from the first fiber reinforced thermoplastic, is then disposed on the other surface of the core layer. Optional additional heating is applied to soften the disposed second fiber reinforced thermoplastic sheet. The coupled two or three layers can then be compressed or further processed. For example, pressure and/or temperature may be applied using processes such as molding, thermoforming, etc. to assist in coupling the sheets to each other and/or to impart a desired shape to the article.

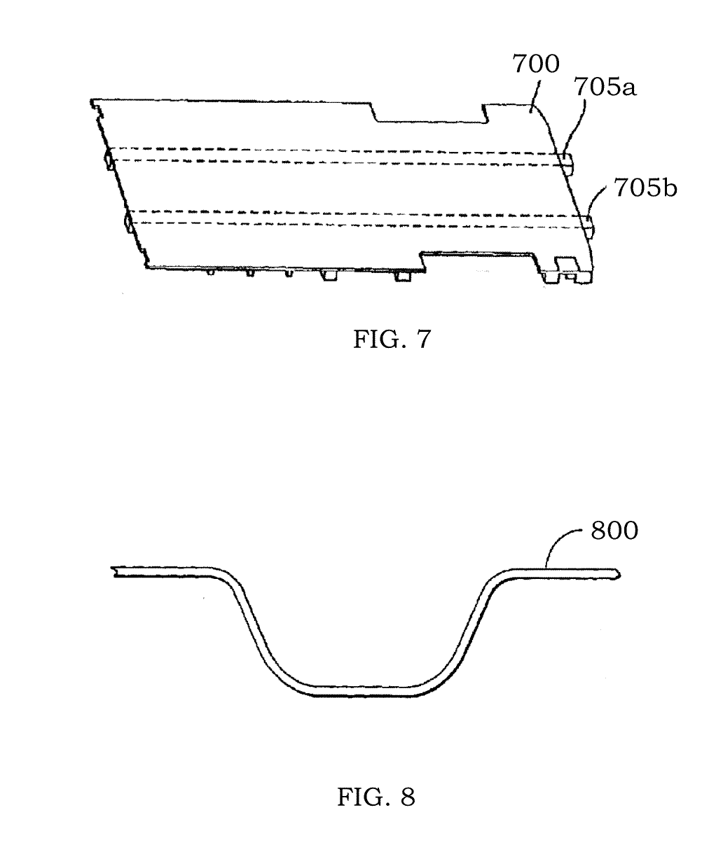

The articles described herein can be processed into a desired configuration or shape using suitable processes including, but not limited to, molding, thermoforming, drawing or other forming processes. In some instances, such processes are used to impart a desired configuration and/or to loft the various layers of the article. For example, where the article is designed to function as a vehicle floor, the floor may be shaped and/or cut in a desired manner. Referring to FIG. 7, a vehicle floor 700 is shown as being disposed and coupled to a vehicle frame comprising components 705a, 705b. The floor 700 is a generally planar structure comprising one or more of the multi-layer assemblies described herein, e.g., those shown and described in connection with FIGS. 1-6C, or other similar multi-layer assemblies that will be selected by the person of ordinary skill in the art, given the benefit of this disclosure. The floor 700 may be coupled to the frame through suitable fasteners such as bolts, screws and the like and optionally with one or more adhesives. In some instances, doors, a roof assembly and other components of the vehicle may be disposed onto the floor 700 to provide a user cabin. If desired, a carpet, foam padding, and the like may be coupled to the floor 700 for aesthetic or other reasons.

In some embodiments, a load floor for a rear storage compartment may be produced using the articles described herein. Referring to FIG. 8, a side view of a deep drawn article 800 that can be used as a load floor is shown. The article 800 is typically positioned in the rear portion of the vehicle, e.g., a rear storage portion of a sport utility vehicle or minivan, and is designed to receive components, gear, luggage, a spare tire, etc. for storage. A lid or covering (not shown) may also be present to enclose the components within the load floor 800 and shield them from view. The load floor 800 may comprise, for example, any of the multi-layer assemblies described herein, e.g., those shown and described in connection with FIGS. 1-6C, or other similar multi-layer assemblies that will be selected by the person of ordinary skill in the art, given the benefit of this disclosure. In some instances, the load floor 800 provides sufficient weight bearing capacity so that no underlying support members from the vehicle need be present to support it.

In some embodiments, the load floor can include structural members or slats to provide additional strength if desired. For example, one, two, three or more metal bars or members can be positioned within the load floor, e.g., in the core layer or in any other layer, to provide for additional strength. Certain configurations of a load floor may provide no more than a desired amount of deflection under a selected weight, e.g., as tested using ASTM D790-10 dated Apr. 1, 2010. If a particular load floor construction deflects more than a desired amount, e.g., no more than 10 mm of deflection under a 100 kg load, then the core layer or the other layers can be altered, e.g., by altering the materials and/or by including structural members, to provide a load floor that meet a desired specification.

In some embodiments, the articles described herein may be configured in the form of a vehicle exterior or hull, e.g., a recreational vehicle exterior panel, a boat hull or other structural panels that may need to withstand some weight or force. The panels are particular desirable for use in higher humidity environments as the core layers are not generally sensitive to water exposure and the properties do not change to a substantial degree upon exposure to water.

In certain embodiments, the articles described herein may be configured in the form of a vehicle interior wall, ceiling or floor, e.g., a recreational vehicle interior wall, ceiling or floor panel that may need to withstand some weight or force. The panels are particular desirable for use in higher humidity environments as the core layers are not generally sensitive to water exposure and the properties do not change to a substantial degree upon exposure to water.

In other configurations the articles described herein can be used as structural components in vehicles. For example, the articles may be present in cabin bunks in over the road vehicles and recreational vehicles, e.g., the articles can be used in fold-down beds, fold down or configurable dinettes which can form a bed, or in other applications where a human may sleep. In some examples, the articles can be present in slide-out structures in recreational vehicles (RV) designed to extend away from an exterior surface of the RV to provide increased interior space. The lightweight nature of the articles can reduce the overall weight of the slide-out structure and place less stress on the gears and motors used to extend and retract the slide-out structures. In addition, the water resistant nature of the articles can provide slide-out ceilings which resist warping and mold growth.

In certain examples, the exact nature of the core layer and the other layers selected may depend, at least in part, on the desired acoustic properties of the article including the various layers. For example, certain configurations of the core layers described herein can provide excellent sound absorption but may not have desired sound barrier properties. A skin or other layer can be selected whose acoustic properties complement that of the core layer to provide a composite structure with good sound absorption and sound barrier properties.

In some embodiments, the core layer of the articles described herein can be water resistant. For example, in many configurations of a load floor, the core layer may be a paper based material. Exposure of the paper based material to water can greatly reduce the core layer strength and can promote mold growth. By using a core layer as described herein, water exposure does not alter the overall strength of the article.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. A multi-layer assembly comprising:
a core layer comprising a closed cell material;
a first reinforced thermoplastic layer disposed on the first surface of the core layer, the first fiber reinforced thermoplastic layer comprising a web of open celled structures formed by a plurality of reinforcing materials bonded together with a thermoplastic material; and
a second reinforced thermoplastic layer disposed on the second surface of the core layer, the second fiber reinforced thermoplastic layer comprising a web of open celled structures formed by a plurality of reinforcing materials bonded together with a thermoplastic material.

2. The multi-layer assembly of claim 1, wherein the closed cell material is not a polyurethane foam or wherein the core layer is cellulose free.

3. The multi-layer assembly of claim 1, wherein the core layer comprises a polyurethane material or a cellulose based material.

4. The multi-layer assembly of claim 1, in which a basis weight of the first reinforced thermoplastic layer is substantially the same as a basis weight of the second reinforced thermoplastic layer.

5. The multi-layer assembly of claim 1, in which a basis weight of the first reinforced thermoplastic layer is different than a basis weight of the second reinforced thermoplastic layer.

6. The multi-layer assembly of claim 1, in which the first reinforced thermoplastic layer disposed comprises at least one different reinforcing material than a reinforcing material of the second reinforced thermoplastic layer disposed.

7. The multi-layer assembly of claim 1, wherein the closed cell material of the core layer comprises a directionally compressive foam that is selected from the group consisting of a directionally compressive expanded polystyrene foam, a directionally compressive extruded polyethylene foam and a directionally compressive expandable polypropylene foam.

8. The multi-layer assembly of claim 1, in which the thermoplastic material in the first reinforced thermoplastic layer is different than the thermoplastic material in the second reinforced thermoplastic layer.

9. The multi-layer assembly of claim 1, in which the thermoplastic material in the first reinforced thermoplastic layer and the second reinforced thermoplastic layer are the same.

10. The multi-layer assembly of claim 9, in which the reinforcing materials in the first reinforced thermoplastic layer and the second reinforced thermoplastic layer are the same.

11. The multi-layer assembly of claim 10, in which the reinforcing materials of the first reinforced thermoplastic layer and the second reinforced thermoplastic layer each comprise reinforcing fibers.

12. The multi-layer assembly of claim 11, in which the first fiber reinforced thermoplastic layer comprises at least one different reinforcing fiber than reinforcing fibers of the second fiber reinforced thermoplastic layer.

13. The multi-layer assembly of claim 11, in which one or both of the first fiber reinforced thermoplastic layer and the second fiber reinforced thermoplastic layer comprise a lofting agent.

14. The multi-layer assembly of claim 13, in which the lofting agent comprises at least one of expandable microspheres and expandable graphite materials.

15. The multi-layer assembly of claim 14, in which no lofting agent is present in the core layer.

16. The multi-layer assembly of claim 11, in which the thermoplastic material and reinforcing materials of the first fiber reinforced thermoplastic layer and the second fiber reinforced thermoplastic layer are selected to permit lofting of the first fiber reinforced thermoplastic layer and the second fiber reinforced thermoplastic layer without a lofting agent being present.

17. The multi-layer assembly of claim 1, further comprising a first adhesive layer disposed on the first surface of the core layer between the first reinforced thermoplastic layer and the core layer.

18. The multi-layer assembly of claim 17, further comprising a second adhesive layer disposed on the second surface of the core layer between the second reinforced thermoplastic layer and the core layer.

19. The multi-layer assembly of claim 18, further comprising a decorative layer disposed on one of the first reinforced thermoplastic layer and the second reinforced thermoplastic layer.

20. The multi-layer assembly of claim 18, wherein the closed cell material of the core layer comprises a directionally compressive expanded polystyrene foam, the first fiber reinforced thermoplastic layer comprises polypropylene and glass fibers, the second fiber reinforced thermoplastic layer comprises polypropylene and glass fibers and the first and second adhesive layers each comprise a co-polyamide.

21-98. (canceled)
